(19) United States
(12) Patent Application Publication
(10) Pub. No.: US 2007/0231773 A1
(43) Pub. Date: Oct. 4, 2007

(54) Methods, Devices, Systems and Kits for Isolating Teeth

(76) Inventors: Curtis Pontynen, San Jose, CA (US); Craig Hines, San Francisco, CA (US); William E. Clem, Bozeman, MT (US); Mark G. Fontenot, Palo Alto, CA (US)

Correspondence Address: WILSON SONSINI GOODRICH & ROSATI, 650 PAGE MILL ROAD, PALO ALTO, CA, 94304-1050, US

(21) Appl. No.: 11/693,689

(22) Filed: Mar. 29, 2007

Related U.S. Application Data
(60) Provisional application No. 60/788,556, filed on Mar. 31, 2006.

(51) Int. Cl. A61C 17/14; A61C 5/00; A61C 17/06

(52) U.S. Cl. 433/140; 433/136; 433/93; 433/29

(57) ABSTRACT

The invention describes methods, devices, kits and systems for isolating one or more teeth. The devices include a topology conformable device that can be constrained into a shape that can be delivered into an oral cavity and unconstrained to allow the device to isolate a target tooth and initiate a working field.

### CROSS-REFERENCE

This application claims the benefit of U.S. Provisional Application No. 60/788,556, filed Mar. 31, 2006, entitled Method and Devices for Isolating Teeth, which is incorporated herein by reference in its entirety.

### BACKGROUND OF THE INVENTION

1. Field of the Invention

This invention is related to dental instruments, devices, systems, kits and methods. More specifically, this invention relates to devices and processes for quickly isolating one or more teeth in an oral cavity of a mammal. The devices facilitate creating and maintaining a dry environment in which to perform a dental procedure and reduces the overall time of the dental procedure by reducing the amount of time spent obtaining and maintaining a working field.

2. Background of the Invention

The mouth or oral cavity 10 of a human is illustrated in FIG. 1A to provide context for the invention. The mouth, or oral cavity, is bounded by muscles and bones: anteriorly by the lips 12, posteriorly continuous with the oropharynx, laterally by the muscles of the cheeks 14, superiorly by the body hard palate and muscular soft palate 16; and inferiorly by the muscular tongue 18 and the soft tissues of the floor of the mouth. The tongue is a voluntary muscular structure that occupies the floor of the mouth. Teeth 20 are embedded in the alveoli or sockets of alveolar ridges of the mandible 30 which forms a mandibular arch 32, or alveolar process, which contain the lower (caudad) set of teeth and maxilla 40 which forms a maxillary arch 42, or alveolar process, which contains the upper (cephalad) set of teeth. Each of the alveolar arch 32, 42, has an external surface 34, 44 which is adjacent the cheeks and lips and an internal surface 36, 46 adjacent the tongue and palate. The teeth 20 engage the gingival tissue 22.

The mouth 10 has salivary glands that secrete about 1.5 L of fluid daily into the mouth. Secretion of saliva is controlled by the autonomic nervous system. Parasympathetic stimulation causes vasodilation and secretion of water saliva with low enzyme content, whereas sympathetic stimulation cases vasoconstriction and secretion of smaller amounts of saliva that are richer in organic materials. Reflex secretion occurs when, for example, there is food in the mouth.

During dental procedures, the oral cavity is constantly filled with saliva. However, many dental procedures require the practitioner to have a dry working environment in order to achieve optimum performance of the restoration materials used. For example, procedures such as cavity removal and repair, crown and bridge work, fluoride treatments, application of pit and fissure sealants, to name a few, require that the dental practitioner first achieve a dry environment. These procedures take, on average, from one hour to several hours, depending on the complexity of the procedure. Current procedures require that the dentist periodically stop work and take steps to regain a dry working field.

Thus, dental practitioners routinely spend anywhere from 30-50% of their time throughout a procedure battling the natural and continuous secretion of saliva in order to obtain, and maintain control of, a dry working field at the point of treatment (e.g., one or more teeth, or gum tissue surrounding teeth). Typically this translates into a minimum of 5-15 minutes at the initiation of the dental procedure to isolate and initiate a working field, with interim efforts to maintain dryness during the procedure. Field control is often the most frustrating part of a dental procedure. Additional problems that may be encountered by a dental practitioner while performing a dental procedure include: maintaining the patient's mouth open, separating the cheeks and tongue from the treatment area, and maintaining a dry (saliva free) working field. In practice the impact of failing to secure a dry working field in the oral cavity during the dental procedure can, in practice, mean the difference between a crown that lasts six months or 30 years.

Devices and systems currently known and used in the dental arts include those disclosed in: U.S. Pat. Nos. 4,695,253 to Tysse for Oral Evacuation Device and Method; 6,981,870 to Heasley for Tubber Dam Clamps Retained by Adhesion and Improved Frictional Forces; 6,974,321 to Hirsh et al. for Intraoral Device; 6,309,625 to Jensen et al. for One-Part Dental Positions and Methods for Bleaching and Dessensitizing Teeth; 6,267,591 to Barstow for Dental Prop, Throad Dam and Retractor; 6,193,513 to Pancallo for Dental Device Acting as a Variable Height Mouth Opener, a Saliva Ejector and an Oral Dam; 6,022,214 to Hirsch et al. for Intraoral Illumination Device and Method of Using Same; 5,931,673 to Bobolan for Intraoral Dental Dam; 5,890,899 to Sclafani for Dental Isolator; 5,803,734 to Knutson for Dental Dam Support and Method of Use; 5,759,038 to Fischer for Dental Kit for Applying Sticky Dental Bleaching Composition's to a Person's Teeth; 5,516,286 to Kushner for Dental Isolation Tray Particularly Suited for Use When Applying Dental Sealants and Method for Its Use; 5,499,917 to Erickson et al. for Dental Isolation Dam; 5,466,153 to Poindexter for Prop for Use in Dentistry and Oral Surgery; 5,460,524 to Anderson for Device and Method for Saliva Suction with Tongue Retractor and Bit Handle; 5,360,341 to Abramowitz for Method and Appliance for Promoting the Healing of Oral Tissues; 5,328,364 to Doyle for Dental Clamp; 5,104,317 to Riazi for Elastomeric Cord for Retaining a Dental Dam, Cord Disspenser and Related Combinations and Methods; 5,098,299 to Fischer for Compositions and Methods for Repairing and Sealing Rubber Dams and Isolating Tissue; 5,078,604 to Malmin for Dental Barrier Drape Devices and Retainer Apparatus Therefor; 5,037,298 to Hickham for Apparatus and Improves Process for Removing Saliva While Retracting Cheeks and Lips; 5,011,409 to Gray for Polyurethane Intraoral Dam; 4,899,490 to Jenkinson for Dental Mask; 4,828,491 to Gray for Unitary Preassembled Displosable Intra-Oral Rubber Dam Device; 4,512,742 to Shanel for Holder for Rubber Dental Dam; 4,215,477 to Shanel for Holder for Rubber Dental Dam; 4,204,329 to Kahn for Rubber Dam Holder for use During Endodontic Therapy; 4,053,984 to Moss for Mouth Prop; 3,772,790 to Swan-Gett et al. for Tooth Isolating Shield; and U.S. Patent Publication US 2004/0170945 to Heasley for General Field Isolation Rubber Dams without Operative Inserts Which Isolate the Dental Alveolar Arch for Dental Treatment.

Commercially available devices include, for example, Isolite i2 by Isolyte Systems (Santa Barbara, Calif.), described at www.isolitesystems.com; OptiDam by KerrHawe SA (Switzerland), described at www.kerrhawe.com; OptraGate by IvoClar Vivident Ltd. (New Zealand), described at www.ivoclar.co.nz; and DentaPops by DentaPops (Sacramento, Calif.), described at http://dynaflex.com/en-us/dept_{—}329.html.

It would be beneficial to have a device, system, kit and method that enables dental practitioners to quickly isolate one or more teeth and/or gingival tissue in the oral cavity from surrounding tissue to generate a working field and which maintains a dry working field for performing the dental procedure.

### SUMMARY OF THE INVENTION

An aspect of the invention is directed to a tooth isolation device. The device is a topology conformable device that can be constrained into a shape that can be delivered into an oral cavity and unconstrained to allow the device to isolate a target tooth and initiate a dry working field. Additionally, the device of the invention can comprise: a first flexible interior structure adapted and configured to engage an interior surface of an alveolar arch within the oral cavity; and a first flexible exterior structure, connected to the interior structure, adapted and configured to engage an exterior surface of the alveolar arch. In other designs, the device also comprises: a second flexible interior structure adapted and configured to engage an interior surface of a second alveolar arch within the oral cavity; and a first flexible exterior structure, connected to the interior structure, adapted and configured to engage an exterior surface of the second alveolar arch.

Another aspect of the invention is directed to a tooth isolation device for use in a mammal. The device comprises a first flexible interior structure adapted and configured to engage an interior surface of an alveolar arch within the oral cavity; and a first flexible exterior structure, connected to the interior structure, adapted and configured to engage an exterior surface of the alveolar arch, wherein the isolation device adapted and configured to fit a topology of a mouth cavity to retract tissue from contacting the alveolar arch to initiate a working field, wherein the device is adapted and configured to be deployed in less than two minutes.

Still another aspect of the invention is directed to a device comprising a first flexible interior structure adapted and configured to engage an interior surface of an upper alveolar arch within the oral cavity; a first flexible exterior structure, connected to the interior structure, adapted and configured to engage an exterior surface of the upper alveolar arch, a second flexible interior structure adapted and configured to engage an interior surface of a lower alveolar arch within the oral cavity; a second flexible exterior structure, connected to the interior structure, adapted and configured to engage an exterior surface of the lower alveolar arch, wherein the isolation device adapted and configured to fit a topology of a mouth cavity to deflect tissue from contacting the alveolar arch to initiate a working field, and further wherein the device is adapted and configured to be deployed to isolate in a single step.

Further aspects of the invention are directed to a tooth isolation device comprising a device that is configured to be deliverable into a patient's oral cavity and configured to deflect tissue away from one or more alveolar arches in the oral cavity while allowing fluid from one or more glands in the oral cavity to flow away from the alveolar arches and teeth.

Another aspect of the invention is directed to an integrally formed tooth isolation dental device for use in an oral cavity of a mammal comprising: a first flexible interior structure adapted and configured to engage an interior surface of an alveolar arch within the oral cavity, further comprising a first interior seal, along at least a portion of a first edge thereof, adapted and configured to draw fluid from the interior surface of the alveolar arch during deployment; and a first flexible exterior structure, connected to the interior structure at a posterior end, adapted and configured to engage an exterior surface of the alveolar arch, further comprising a first exterior seal, along at least a portion of a first edge thereof, adapted and configured to draw fluid from the exterior surface of the alveolar arch during deployment, and a curved trough at an opposing edge to the first edge adapted and configured to deflect tissue away from the alveolar arch, the tooth isolation device being dimensioned to fit over one or more of an upper alveolar arch, a lower alveolar arch, an upper quadrant of the alveolar arch, and a lower quadrant of the alveolar arch.

Yet another aspect of the invention is directed to a dental device for use in an oral cavity of a mammal comprising: a first flexible caudad interior wall adapted and configured to engage an interior caudad arch of the tooth within an oral cavity of a mammal, further comprising an interior caudad seal along at least a portion thereof adapted and configured to draw fluid from the interior arch of the oral cavity during deployment; a first flexible caudad exterior wall, connected to the interior wall, adapted and configured to engage an exterior caudad arch of an oral cavity of a mammal, further comprising an exterior caudad seal along at least a portion thereof adapted and configured to draw fluid from the exterior arch of the oral cavity during deployment; a first flexible cephalad interior wall adapted and configured to engage an interior cephalad arch of the tooth within an oral cavity of a mammal, further comprising an interior cephalad seal along at least a portion thereof adapted and configured to draw fluid from the interior arch of the oral cavity during deployment; a first flexible cephalad exterior wall, connected to the interior wall, adapted and configured to engage an exterior cephalad arch of an oral cavity of a mammal, further comprising an exterior cephalad seal along at least a portion thereof adapted and configured to draw fluid from the exterior arch of the oral cavity during deployment.

Further aspects of the invention are directed to a tooth isolation device comprising a device that is configured to be deliverable into a patient's oral cavity comprising a light delivery apparatus incorporated therein adapted and configured to deliver light to a target portion of the oral cavity.

Any of the devices of the invention can be adapted and configured to have one or more of the following features. For example, devices can be adapted and configured to isolate a working field from gingival tissue and/or from fluid. In at least some aspects, the devices can be adapted and configured to form a customizable seal within the oral cavity. Yet another aspect of the device can include tongue deflector. A variety of lumens can be provided, for example, a lumen within at least one of the interior structure or the exterior structure and one or more fluid apertures along the length of the lumen communicating the lumen with an interior of the oral cavity. In other designs, an external suction attachment port can be provided that is operably connected to the lumen. A variety of fluid apertures can also be provided, for example, one or more ventral apertures, sub-lingual apertures and bucal apertures. In yet another aspect of the invention, a foam border is provided. In other designs, a compliant flexible connector is provided that is adapted to connect, either as a separate piece or formed integrally with, the first flexible exterior structure to the second flexible exterior structure. Other aspects of the invention include devices that include a light source, which is either adapted and configured to engage the device and provide light from an external source, or incorporated within the device. A variety of apertures can also be provided along the devices, such as apertures that permit or facilitate breathing. When implanted, the device can be adapted and configured to fit within the oral cavity to deflect one or more tissues away from the alveolar arch of the oral cavity. Yet another aspect of the invention is that the devices can be deployed in the oral cavity and seated in under 2 minutes, preferably in under 1 minute and more preferably in under 30 seconds. Thus, the devices initiate a working field in the oral cavity in under 2 minutes. An additional feature of the devices of the invention is that the devices can be adapted and configured to dispense a lubricant, a topical anesthesia, a fluid. Additionally, an inflatable membrane, such as a fluid filled inflatable membrane, can be provided that isolates one or more target sections of teeth and gums, which comprise the working field. One or more seals can be provided that are adapted and configured to isolate a target area of the alveolar arch to create a saliva barrier within the oral cavity. The seals can take any of a variety of configurations adapted and configured to securely isolate a target region of teeth and/or gums from select soft tissues of the oral cavity. Configurations of the device can include a structural frame, such as a reusable structural frame, with a flexible biocompatible material surrounding the frame, such as a disposable sleeve adapted and configured to fit over the frame.

Aspects of the invention also include methods of achieving a working field in an oral cavity. The methods comprise the steps of: inserting a dental device adapted and configured to draw fluid from an alveolar process and gingiva when engaged in the oral cavity; drawing the dental device over the alveolar process; seating the device within the oral cavity; and isolating the working field from fluid during the procedure. In practice, the step of inserting the dental device is performed in under 2 minutes. Further steps of the method can include either or both applying air to a target region in the oral cavity engaged by the device, or withdrawing air from the target region. Additionally, the method can further comprise withdrawing fluid from the oral cavity through ejection apertures situated within the device, and/or activating a light source within the device to illuminate at least a portion of the oral cavity.

Another method of achieving a working field in an oral cavity can comprise the steps of: inserting a dental device adapted and configured to draw fluid from the oral cavity during use; drawing the dental device over the alveolar process; and applying suction to the dental device to withdraw fluid from the oral cavity through ejection apertures situated within the device. In practice, the step of inserting the dental device is performed in under 2 minutes. Further steps of the method can include either or both applying air to a target region in the oral cavity engaged by the device, or withdrawing air from the target region. Additionally, the method can further comprise withdrawing fluid from the oral cavity through ejection apertures situated within the device, and/or activating a light source within the device to illuminate at least a portion of the oral cavity.

Still another aspect of the invention is directed to a method for illuminating an oral cavity. The method comprises the steps of: inserting a dental device adapted and configured to isolate a target region of an alveolar process and gingiva; drawing the dental device over the alveolar process to expose the target region of the alveolar process and gingiva; and activating a light in the dental device. In practice, the step of inserting the dental device is performed in under 2 minutes. Further steps of the method can include either or both applying air to a target region in the oral cavity engaged by the device, or withdrawing air from the target region. Additionally, the method can further comprise withdrawing fluid from the oral cavity through ejection apertures situated within the device.

Another method of the invention initiates a working field by: inserting a dental device adapted and configured to isolate a target region of an alveolar process and gingiva in under 2 minutes. In practice, the step of inserting the dental device is performed in under 2 minutes. Further steps of the method can include either or both applying air to a target region in the oral cavity engaged by the device, or withdrawing air from the target region. Additionally, the method can further comprise withdrawing fluid from the oral cavity through ejection apertures situated within the device, and/or activating a light source within the device to illuminate at least a portion of the oral cavity.

Yet another aspect of the invention is directed to kits for achieving a working field in an oral cavity comprising: a dental device adapted and configured to draw fluid from an alveolar process and gingiva after engaging the oral cavity; and a kit of a secondary dental procedure where a working field in the oral cavity is desirable. The kit can be a variety of types. One example, is a kit comprising an impression kit to facilitate laboratory fabrication of dental restorations. Another example, is a kit comprising a porcelain bonding system having veneers, and porcelain cement. Yet another kit comprises a whitening or bleaching kit, or a restorative materials kit. Some kits can contain light delivery device accessories and/or apparatuses. Still other kits can include try-in devices adapted configured to be placed within the oral cavity in order to assess a size of the cavity and/or one or more disposable sheaths adapted and configured to fit over a structural frame of the dental device and/or one or more shields.

### INCORPORATION BY REFERENCE

All publications, patents and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1A depicts an anterior view of an oral cavity with the mouth open and the teeth exposed illustrating the structures of the oral cavity; FIG. 1B is an illustration of a human body with the anatomical planes of the body identified;

FIG. 2 illustrates an embodiment of a dental device as positioned in the mouth of a patient; FIG. 2A illustrates the dental device as positioned in the mouth of a patient; FIG. 2B is an anterior view of the device as position in the mouth of a patient, zooming in on the device itself; FIG. 2C is depicts the dental device as positioned in the mouth of a patient viewed from an anterior 45 degree angle; FIG. 2D depicts the dental device positioned over a caudad portion of the mouth; FIG. 2E illustrates a sagittal plane side view of the dental device positioned in the mouth of a patient lying in a supine position, as viewed from the patient's right side; FIG. 2F is a cephalad facing view of a patient's mouth with the dental device in position; FIG. 2G is caudad facing view of a patient's mouth with the dental device in position; FIG. 2H is a top view of the dental device; FIG. 2I is an illustration of a cross section of FIG. 2H along the line B-B as shown, as viewed from the midline toward the left side of the device; FIG. 2J is an illustration of the cross section through a sagittal plane of FIG. 2I together with anatomy;

FIG. 3 illustrates a solid barrier dental device; FIG. 3A is a perspective view of the posterior or distal end of the dental device from the top and at a 45 degree angle; FIG. 3B illustrates the dental device from the back or distal portion; FIG. 3C illustrates the dental device from the left; FIG. 3D illustrates the dental device from a top view; FIG. 3E illustrates a cross section of the device shown in FIG. 3D along the line B-B; FIG. 3F illustrates an anterior view of the dental device positioned within the oral cavity of a patient;

FIG. 4 illustrates a structural frame design of a dental device with cutout areas; FIG. 4A is a perspective view of the posterior or distal end of the device viewed from the top and at a 45 degree angle; FIG. 4B illustrates the dental device from the bottom; FIG. 4C illustrates the structural frame design from the distal end; FIG. 4D illustrates the structural frame design from the left side of the device;

FIG. 5 illustrates a dental device having spring frame compliance; FIG. 5A illustrates the spring frame capable of single arch isolation of either the top (upper or caudad section) or bottom (lower or cephalad section) of the oral cavity; FIG. 5B illustrates a spring frame dental device capable of left half or right half, upper and lower arch isolation; FIG. 5C illustrates an upper surface view of top and bottom portions of an unassembled spring frame; FIG. 5D illustrates a top view of a flattened dental device; FIG. 5E illustrates a frontal view at a 45 degree angle of the dental device positioned within the oral cavity of a patient;

FIG. 6 illustrates a flat isolation device with suction and frame; FIG. 6A is a top view of the flattened device with suction tubes and a structural frame; FIG. 6B is a front view of the assembled device with suction tubes and a structural frame; FIG. 6C is a frontal view at a 45 degree angle of the device with suction tubes and structural frame as positioned within the oral cavity of a patient;

FIG. 7 illustrates a frontal view of a dental device positioned within the oral cavity of a patient isolating half of the oral cavity; FIG. 7A illustrates the dental device positioned in the oral cavity of a patient isolating the left or right side of the oral cavity of a patient; FIG. 7B is a frontal view of a dental device positioned in the oral cavity of a patient isolating the top or bottom half of the oral cavity of a patient;

FIG. 8 illustrates an accordion style dental device adapted and configured to achieve greater lip retraction with the device extruding out of the mouth; FIG. 8A is a perspective view of the posterior end of the dental device with a solid state barrier as viewed from the top and at a 45 degree angle; FIG. 8B illustrates a top view of the dental device; FIG. 8C illustrates an the back of an accordion style dental device; FIG. 8D is the right side of a cross section of FIG. 8D along the line A-A; FIG. 8E is a side view of an accordion style device;

FIG. 9 illustrates a dental device with a foam border and a saliva evacuation/suction tube attachment adapted and configured to perform suction through an open cell foam; FIG. 9A is a perspective view of the posterior end of a dental device with a foam border and a suction tube attachment as viewed from the top and at a 45 degree angle; FIG. 9B illustrates a top view of the dental device; FIG. 9C illustrates a back end of the dental device; FIG. 9D illustrates a cross section of FIG. 9C along line A-A; FIG. 9E illustrates the dental device with a foam border and a suction tube attachment;

FIG. 10 illustrates a dental device with a sub-lingual and low buccal saliva ejection/suction; FIG. 10A is a perspective view of the dental device with sub-lingual and buccal suction as viewed from the top and at a 45 degree angle; FIG. 10B is a top view of a dental device; FIG. 10C is a back end view of the dental device; FIG. 10D is a cross section view of FIG. 10C along line A-A; FIG. 10E is the dental device from the right side;

FIG. 11 illustrates a dental device with suction tube for saliva evacuation positioned at the back end of the device; FIG. 11A is a perspective view of the dental device; FIG. 11B is a top view of the dental device; FIG. 11C is view of the dental device from the back end having a compliant flexible area between an upper component and a lower component; FIG. 11D is a cross-sectional illustration of the device of FIG. 11C along line A-A; FIG. 11E is a view of the dental device from the right side;

FIG. 12 illustrates a dental device integrating a light source; FIG. 12A is a perspective view of the dental device viewed from the top and at a 45 degree angle; FIG. 12B is a bottom view of the dental device; FIG. 12C is a back end view of the dental device; FIG. 12D is a cross sectional view of the device of FIG. 12C along the line A-A through a sagittal plane from a midline toward a patient's left; 12D is a left side of a dental device integrating a light source;

FIG. 13 illustrates a full seal suction tube component for a dental device; FIG. 13A is a perspective view of the back end of a full seal suction tube component for the dental device as viewed from the top and at a 45 degree angle from the left; FIG. 13B is a top view of a full seal suction tube component of the dental device; FIG. 13C is a perspective view of the back end of a full seal suction tube component of the dental device from the top and at a 45 degree angle from the right; FIG. 13D is the dental device viewed from the back; FIG. 13E is a cross sectional view of the device of FIG. 13D along line A-A; FIG. 13F is an illustration of the left side of a full seal suction tube component of a dental device;

FIG. 14 illustrates a dental device with no center aperture or tongue deflector; FIG. 14A is a perspective view of a dental device as viewed from the top and at a 45 degree angle; FIG. 14B is an illustration of a back end of the dental device of FIG. 12A; FIG. 12c is a side view of the dental device;

FIG. 15 illustrates a dental device having a flexible frame with a seal; FIG. 15A is a perspective view of a dental device as viewed from the top and at a 45 degree angle; FIG. 15B is an illustration of a back end of the dental device of FIG. 15A; FIG. 15C is a side view of the dental device; FIG. 15D is a top view of the dental device;

FIG. 16 illustrates a dental device positioned in the oral cavity of a patient showing the interface between the device and the oral cavity; FIG. 16A is a top down view of a dental device as positioned over the lower half of an oral cavity. FIG. 16B is an enlarged view of a seal configuration for use in the dental devices of the invention; FIGS. 16C-16H are illustrations of various embodiments of a various seal configurations suitable for use with the dental devices of the invention; FIG. 16c illustrates a wiper-blade type seal; FIG. 16d illustrates a cylindrical seal formed of a suitable material such as foam, elastic, putty, or hydrophillic material; FIG. 16e illustrates a solid thin seal adapted and configured to isolate one or more teeth only; FIG. 16f illustrates a wiper-type seal with a suction component incorporated therein; FIG. 16g illustrates an apparatus adapted and configured to provide a suction feature internally positioned relative to the seal; FIG. 16h illustrates a device using a slow recovery foam seal border;

FIG. 17 illustrates an insertion process for positioning a dental device within the oral cavity of a patient; FIG. 17A is an illustration of one embodiment of a dental device as ready to be inserted; FIG. 17B shows a first step for positioning the dental device consisting of reducing the profile of the device; FIG. 17C shows a second step for positioning the dental device in which the device is beginning to be inserted into the oral cavity; FIG. 17D shows a example of a third step in positioning the dental device along the alveolar processes; FIG. 17E shows a example of the device as positioned in the oral cavity of a patient completed within 10 seconds;

FIG. 18 is an example of a system or kit according to the invention; and

FIG. 19 is an example of the manufacturing steps for preparing a device according to the invention.

### DETAILED DESCRIPTION OF THE INVENTION

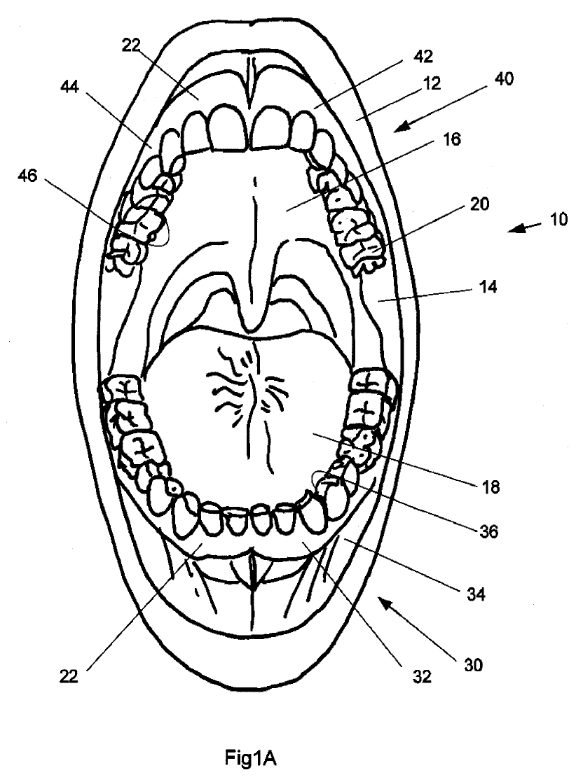

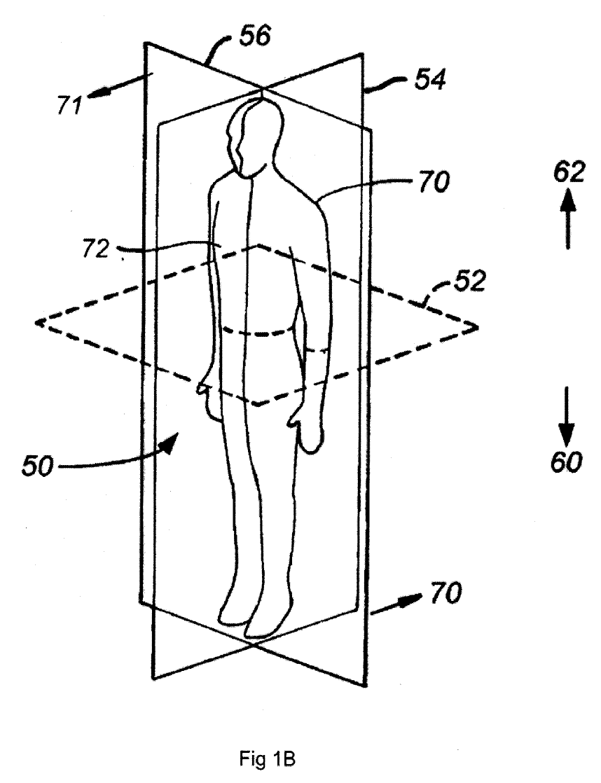

In order to understand the configurability, adaptability and operational aspects of the invention, it is helpful to understand the anatomical references of the body 50 with respect to which the position and operation of the device, and components thereof, are described. There are three anatomical planes generally used in anatomy to describe the human body and structure within the human body: the axial plane 52, the sagittal plane 54 and the coronal plane 56 (see FIG. 1B). Additionally, devices and the operation of devices are better understood with respect to the caudad 60 direction and/or the cephalad direction 62. Devices positioned within the body can be positioned dorsally 70 (or posteriorly) such that the placement or operation of the device is toward the back or rear of the body. Alternatively, devices can be positioned ventrally 72 (or anteriorly) such that the placement or operation of the device is toward the front of the body. Various embodiments of the device for isolating teeth, systems and kits of the present invention may be configurable and variable with respect to a single anatomical plane or with respect to two or more anatomic. Similarly, the various components can incorporate differing sizes and/or shapes in order to accommodate differing patient oral cavity sizes.

The present invention contemplates devices adapted and configured to isolate one or more teeth in one or more alveolar arches of the oral cavity. By isolating the target teeth, the target teeth are set apart or kept away from other tissue, saliva and debris to create a site within the oral cavity suitable to perform a dental procedure. As will be appreciated by those skilled in the art, because the teeth are embedded in the jaw bone, a target tooth is not per se “isolated” from a neighboring tooth. However, the devices, can be configured such that the target tooth is isolated from a neighboring tooth such that the neighboring tooth is not impacted by the use of dental materials during a procedure on the target tooth. Isolation of one or more target teeth can also include exposing those teeth to create a surgical site, or site for performing a procedure.

Additionally, the devices are adapted and configured to further isolate one or more teeth from soft tissue, e.g. gums, cheeks, tongue, and saliva. Such isolation devices can provide a controlled and, when necessary, a dry environment for a dental practitioner. Additionally, the devices are adapted and configured to achieve a dry working field (e.g., the location of the one or more teeth that are the target for a procedure) as well as maintain the dry working field for a longer period of time without intervention (e.g., without the dentist stopping the procedure to gain control of the surgical field). The devices are further configured such that they are rapidly deployed; quickly achieve a dry working field and substantially maintain the working field condition during the procedure without the need for interaction.

In some embodiments, an isolation device of the present invention is a single unit apparatus that can be positioned within a patient's mouth to isolate one or more of the patient's teeth. For example, an isolation device can be a single arch that isolates only the upper teeth or a portion thereof or a single arch that isolates only the lower teeth or a portion thereof. Such single-arch devices which isolate only lower or upper teeth can be used independently or in combination with one another to form a two piece device. In some embodiments, a single arch (e.g., lower arch) isolation device is coupled to a paddle that isolates the other half of the mouth (e.g., the upper teeth) and/or keeps the mouth open. In some embodiments, an isolation device (single arch, two single arches, or a full mouth single unit device) is further coupled to a drape such that when the device is deployed the drape extends from the device external to the mouth and drapes the patient's face region surrounding the mouth thus preventing debris from contacting a patient's nose, eyes, or other parts of the face. Since the device herein is shaped like the mouth, to be inserted into a patient's mouth accurately in one minute or less or 30 seconds or less.

The isolation devices herein include one or more deflectors. A deflector is an element that deflects, retracts, or displaces soft tissue, such as lips, tongue and/or cheek(s), away from teeth and/or alveolar surfaces. In some embodiments, an isolation device comprises one deflector. In some embodiments, an isolation device comprises two deflectors. Additional deflectors can be used, especially when each deflector uniquely retracts a different portion of the cheek(s) and/or lip(s).

Isolation devices can further be adapted and configured to provide one or more apertures that correspond with one or more upper and/or lower teeth. A lower deflector may be provided adjacent an aperture for the lower teeth such that it is adapted and configured to extend or protrude the lower lip and cheeks away from the lower teeth, or at least a target lower tooth, e.g. where only one tooth is exposed through the lower tooth aperture. Similarly, an upper deflector may be positioned adjacent an aperture corresponding to one or more upper teeth, wherein the deflector is adapted and configured to extends or protrude the upper lip and cheeks away from the upper teeth, or at least a target upper tooth. The upper and/or lower teeth can be inserted into such tooth receiving apertures without impinging on the patient's teeth and without forceful contact with the alveolar process or gingiva. In some embodiments, additional regions of interest (e.g., gums) may be exposed by removing (such as by cutting) one or more parts of the isolation device as necessary.

The deflector can have various dimensions to achieve suitable to achieve creation of a working field around a target tooth or teeth. Thus, the length, height, curvature, and width can be adjusted to take into account the size of the mouth and/or the facial features of the patient. For example, in some embodiments, deflectors can be configured to increase in size as the deflector extends away from the alveolar arch to allow for retraction of more cheek muscle. In some embodiments, a lower deflector and/or an upper deflector is between 1 mm-10 cm in height. Deflectors for children, adults, and animals can have different lengths, widths, curvatures etc.

The lower and upper deflectors can be adapted to extend to the back of the mouth where the deflectors interconnect. For example, the lower and upper deflectors may be connected on both the right and left back (posterior) sides of the mouth, e.g. immediately posterior the most posteriorly positioned tooth, via a flexible bridge that permits the patient to open and close their mouth with the device fully deployed therein. Such bridge can include, for example, one or more features adapted to increase flexibility or rigidity. In some embodiments, the bridges comprise folds, bellows or ribs which increase its elasticity. In some devices, the bridges are made of a different material than the deflectors. Additionally, the lower and upper deflectors can be connected via an inflexible bridge forcing a patient to keep their mouth open at a specified angle. In some embodiments, the bridges are designed to help keep a patient's mouth open but also provide flexibility to permit closing of the mouth.

A flange or bridge (such as “webbing”) can also be provided that connects the anterior portion of the lower deflector prevents the tongue from dislodging the device by positioning the tongue over the top of the webbed portion described.

The bridges in the back of the mouth can be coupled to or extend into a shield that prevents debris and other components from entering the throat during a dental procedure. The shield can have a proximal curvature to allow extra room for the tongue. In some embodiments, the shield curvature is such that the apex of curvature is in the center of the mouth. In some embodiments, the shield can further act as a tongue containment device, tongue suppressor, tongue elevator, tongue support, etc. In some embodiments, the shield comprises an aperture in its center to permit a patient to breathe using their mouth. The aperture allows the patient to breath through the mouth. Additionally, the aperture may be large enough such that the patient can put their tongue into and/or through the aperture. The aperture can also be used to provide access to the back of the mouth e.g. to visualize debris or saliva build-up, as well as to give access to high volume suction.

Some configurations of the shield are configured to function as a tongue deflector comprises a surface that is a unshaped flange extending from the inside of the mouth toward the outside. The bottom surface of the tongue deflector can have an internal surface with side surfaces extending there from to form a barrier between the mouth and the throat. The throat barrier is below the breathing aperture, which permits the patient to breathe through the mouth during the procedure.

In some embodiments, a shield is used to maintain the patient's mouth open. Such shield has a support mechanism above the breathing cavity. The support mechanism may be a u-shaped flange that extends upwardly and externally above the breathing cavity. The support mechanism is adapted to maintain the mouth cavity open. The support mechanism is especially useful for dental surgery, when the patient is unconscious.

Devices of the invention, can also be adapted and configured to integrate with a saliva ejection or suction element. A saliva suction element includes, for example, one or more suction inlets, one or more suction channels, and one or more suction outlets. A suction channel can extend from a region inside the mouth (e.g. posteriorly) to a region near or at the mouth opening (e.g. anteriorly). A suction channel can be integrated into the frame of the isolation device. For example, a suction inlet can be at a region abutting the internal cheek or back of the mouth when the device is deployed. In some embodiment multiple suction inlets align the bottom lower deflectors. Such suction inlets are coupled to a single channel leading to an outlet in the front of the patient's mouth. A suction channel can extend from the suction inlet within the frame of the device, or external to the device, to a suction outlet located at the proximal end of the device herein or proximal to the device herein (external to the mouth). The suction outlet can be coupled to a suction device external to the patient to draw saliva from the back of the mouth outside the patient. A saliva ejection or suction element enhances the seal around the teeth. In some embodiments, suction channels(s) and outlet(s) are located on the underside (meaning the “tissue side”) of the “sealing mechanism” such that the device attaches itself firmly to the alveolar process or upper and lower alveolar processes when suction is applied. The suction actuated sealing mechanism can also consists of a suction channel within the “windshield wiper blade” or deflector element, with perforations positioned in two rows on the tissue side (“underside”) of the seal. In the case of the upper arch portion of the device, the perforations are on the superior surface of the seal. When suction is applied to the channel or channels, via a port or ports near the proximal end of the device, the seal(s) adhere(s) to the alveolar process or processes.

The devices herein can also be integrated with a lighting element. As with other components of the invention, the integrated light can be formed integrally, such that it is a constituent piece of the device, or such that the device ultimately forms a single unit, one component of which is the light fixture. Such devices are composed of a translucent material capable of illuminating once it is inserted into the patient's mouth. In some embodiments, the device comprises LED light source or a fiber optic light source, either of which can, for example, be embedded in the device. The lighting device can also be configured such that it is powered by an external power source or a power source that is not external.

The isolation device herein can be manufactured using an elastic but somewhat stiff wire to form the upper and lower deflectors. The wire can be co-molded in silicone and then encapsulated by a soft polymeric material, for example. In some embodiments, a nickel/titanium alloy wire is used for the frame to optimize the collapsibility of the device for insertion purposes and compliance with mouth shape while providing the forces necessary to accomplish retraction of cheeks and tongue and to position the sealing mechanism. In come embodiments, a nylon or other plastic material is used for this “wire frame.”

The remainder of the isolation devices herein can be made from one or more polymeric materials including, but not limited, to c-Flex-thermal plastic elastomer (TPE), silicon, slow recovery foam (SRF), and polyurethanes (PU). Preferably, a clear polymer is used to manufacture the devices herein. The material can be embossed or pre-molded into the shape of the inside of the mouth which provides extra comfort to the patient. The device can be composed of one or more materials or of a single material having two or more durometers. In one embodiment, a first material conforms to the shape of the alveolar process(es) and creates a seal around one or more of the teeth while the second material provides structure that retracts the cheek(s) and tongue, providing a clear working field for the dental practitioner and comfort and safety for the patient. In any of the embodiments herein, a material can optionally contain a flavored lubricant to facilitate insertion and removal. In some embodiments, the device is molded in the practitioner's office to fit the individual patient. In some embodiments, a practitioner can measure a patient's mouth, using a sterilizable and reusable “tri-in” device, as an aid in selecting the best size of device for the patient. Overall, the device herein can be made in different sizes to fit different size mouths. In some embodiments, a device herein can be used in veterinary dental procedures. Such devices can be adapted to fit an animal being treated (e.g., dog, cat, horse, etc.). The sealing portion of the device can be formed from any suitable hydrophilic material, hydrophobic material, or a putty (e.g., Van-R reversible hydrocolloid, available from Dux Dental, and vinyl polysiloxane, available from 3M Express).

Prior to inserting the device into a patient's mouth, the device has a circular circumference as provided by the upper and lower deflectors. The device may have at least one, two, or three apertures—e.g., one for one or more of the lower teeth, and/or one for one or more of the upper teeth, and/or one for the tongue and/or airway and/or the largest (proximal or posteriorly positioned) aperture which is used for access to the working field. The apertures for the target teeth (either upper or lower) can be formed by implanting the device and punching one or more target teeth through a perforated ridge. In some embodiments, a first aperture is designed to expose/isolate all of the target teeth and is c-shaped; a second aperture is designed to expose/isolate all of the target teeth. The first and second apertures border on their exterior end with deflectors adapted to retract the lips and cheeks away from all teeth. The upper and lower deflectors are coupled in the back of the mouth using flexible bridges that permit the patient to open their mouth at various angles. The bridges are also coupled to a shield with an aperture large enough to allow at least a portion of the patient's tongue to protrude through it.

As will be appreciated by those skilled in the art, the device can be adapted and configured to completely isolate both full arches of teeth and is adapted to permit closing of the mouth. This may allow the upper and lower teeth to come together and permits a dental practitioner to make a judgment about the interaction(s) of upper and lower teeth (e.g., bite). The ability to look at a full arch of teeth also permits judgment based on features of other teeth whether they are being worked on or not (e.g., comparing teeth coloration, etc.). Furthermore, exposing a plurality of teeth permits a dental practitioner to work on more than 1, 2, 3, 4, 5, 6 etc., teeth each of which may be located in a different part of the mouth without having to re-adjust the isolation module/deflector.

The devices are adapted and configured for use in a procedure requiring a dry environment, such as performing restoration (e.g., crown and filling work). Absence of saliva can impact the quality of a tooth impression, especially when making impressions of teeth prepared for laboratory fabricated dental restorations or prostheses. The devices of this invention enable a practitioner to insert the device, optionally perform suction on any saliva that remains in the patient's mouth or perform any other step to facilitate a dry working field, and then insert impression material onto a tooth, remove that impression material and optionally insert a filling material. The device permits an impression to be taken and filling added without removing the device so that no impression or filling material goes down the patient's throat. The device also helps prevent saliva from getting onto the teeth during the entire period it is placed in the mouth.

For surgical procedures, the device can be used to isolate one or more teeth of interest while preventing blood, disposables, implantable parts, implanted related parts, or instruments from getting into the patient's throat.

The invention also contemplates a kit comprising one or more isolation devices with one or more devices or products associated with a particular dental treatment. For example, lasers are currently used in dentistry for various applications including but not limited to: cavity removal, cutting or hardening bonding material, whitening teeth, and re-contouring, reshaping, or removing gum tissue. The device herein can be used in combination with laser therapy to act as a shield and tongue and cheek deflector, preventing other regions of the mouth from being affected by the laser. Thus compounds used with the laser procedure could be provided in the kit with the isolation device or devices, as well as equipment adaptors, etc.

Additionally, a kit comprising one or more isolation devices with one or more complementary automatic impression tray system(s) or implant specific impression tray(s), which are designed to fit over the upper and/or lower arches of teeth, to capture a detailed and accurate impression of each full arch of teeth and the surrounding alveolar process and gingiva, while the isolation device is in place. This prevents any contamination of the impression(s) with saliva and prevents any escape of impression materials into the mouth cavity or the patient's throat.

As described above, FIG. 1A depicts an oral cavity 10 from an anterior 72 view with the mouth 10 open and the teeth exposed 20 and FIG. 1B illustrates a human body with the anatomical planes of the body identified.

### I. Devices

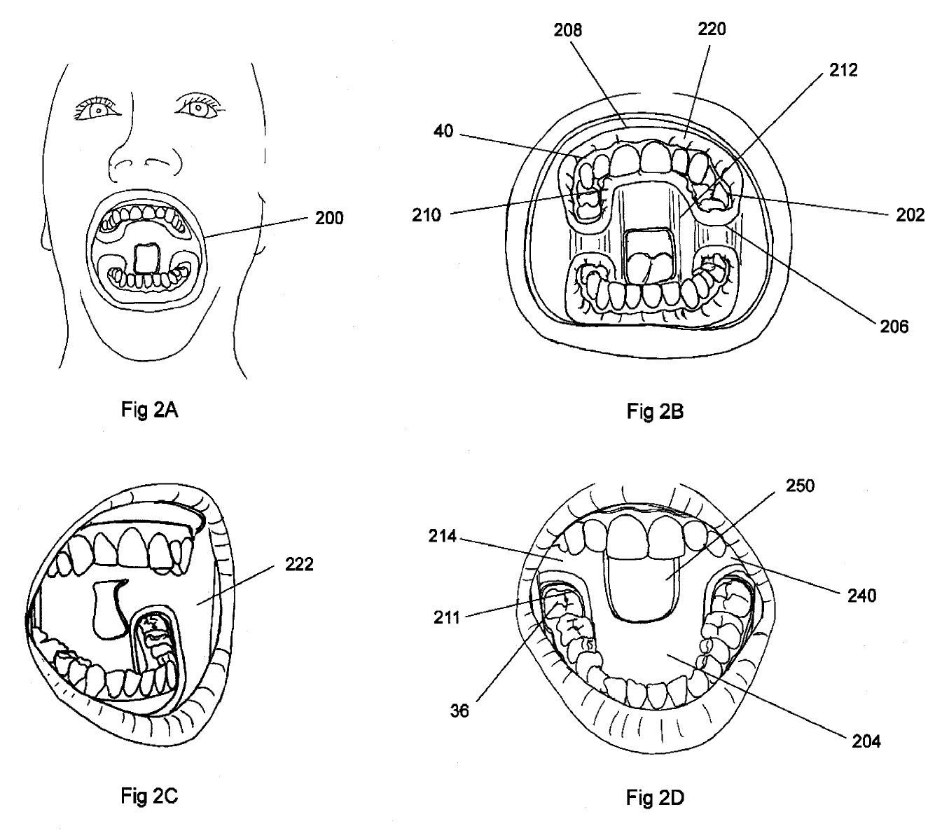

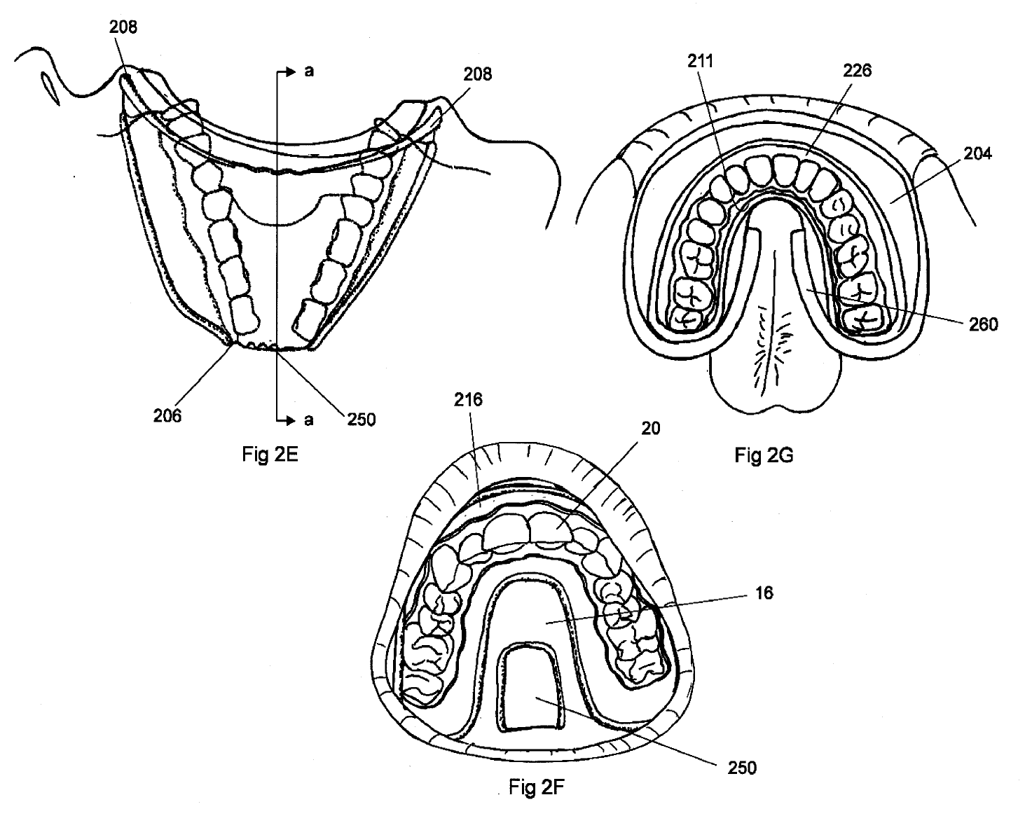

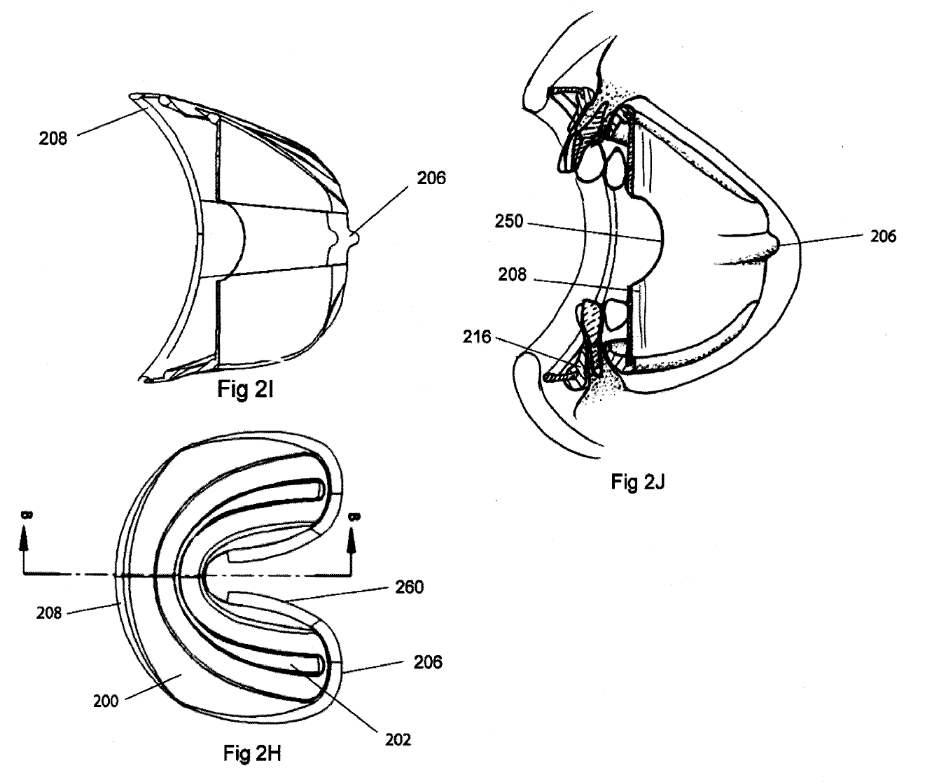

FIG. 2 illustrates a tooth isolation device which is formed from a topology conformable device that can be constrained into a shape that can be delivered into an oral cavity and then unconstrained to allow the device to isolate one or more target teeth and initiate a working field. The device 200 of the invention adapted and configured for full mouth cavity 10 isolation. The device is an integrally formed tooth isolation dental device 200 for use in an oral cavity 10 of a mammal. The integrally formed device can be either formed from one or more components facilitate complete operation of the device or such that it is formed from a single piece. Mammals include, for example, humans, horses, dogs, cats, etc. For purposes of illustration, as shown in FIG. 2A, the device 200 is illustrated deployed distally (i.e. away from the user) into an oral cavity, or mouth, of a future patient. The device 200 is integrally formed such that the device can, as will be discussed further below, be manufactured as a single piece by suitable manufacturing processes. Alternatively, the device 200 can also be comprised of multiple pieces that are fastened, glued or retained as a single piece, or pieces or components that act in a unified manner.

The device 200 is adapted and configured in this embodiment to isolate one or more teeth in a full upper arch and a one or more teeth in a full lower arch of teeth. As will be appreciated by those skilled in the art, variations of the designs and methods disclosed herein can be made to create a device that isolates a quarter of the mouth (e.g., one half of either the mandible or maxilla) or one half of the mouth (e.g., one half of the mandible and an opposing half of the maxilla; or a full arch of either the mandible or maxilla). As shown in FIG. 2B, a frontal view of the device as positioned within the oral cavity of a patient, the maxilla isolation component 202, or upper arch component, has a distal end 206 and a proximal end 208. The distal end 206 is positioned away from the exterior of the patient and anteriorly into the oral cavity. The proximal end 208 is positioned nearest the opening to the oral cavity. The device 200 is comprised of a first flexible interior structure 210, 210′ adapted and configured to engage an interior surface 46 of an alveolar arch 42 of the maxilla 40 within the oral cavity 10. In the embodiment illustrated, the first flexible interior structure 210, 210′ is an upper or cephalad flexible interior structure or flexible sheet that engages an interior surface of the maxilla 40 and extends into an upper conforming surface 212 that covers at least a portion of the upper palate 16. An opposing flexible exterior structure 220, 220′ is an upper or cephalad flexible exterior structure or flexible sheet that engages an exterior surface of the maxilla 40 and extends into a tissue deflector 222 that deflects the cheeks and lips away from the ridge of the maxilla 40 where the teeth 20 are typically positioned, as shown in FIG. 2C. In the embodiment depicted, the flexible interior structure 210 is connected at two connection bridges 214, 214′ and is separated from the flexible exterior structure 220 along at least a portion of a tooth engaging surface by an aperture 226 positioned along the caudad ridge 228 of the maxilla isolation component 202 of the device 200.

As shown in FIG. 2D, a mandible isolation component 204, or upper arch component, is comprised of a first flexible interior structure 211, 211′ adapted and configured to engage an interior surface 36 of an alveolar arch 32 of the mandible 30 within the oral cavity 10. In the embodiment illustrated, the first flexible interior structure 211, 211′ is a lower or caudad flexible interior structure or flexible sheet that engages an interior surface of the mandible 30 and extends into an upper conforming surface 212 that covers at least a portion of the upper palate 16. An opposing flexible exterior structure 220, 220′ is an upper or cephalad flexible exterior structure that or flexible sheet that engages an exterior surface of the maxilla 40 and extends into a tissue deflector 222 that deflects the cheeks and lips away from the ridge of the maxilla 40 where the teeth 20 are typically positioned. Cheeks are typically deflected laterally away from a midline, while the lips are deflected anteriorly (or proximally). In the embodiment depicted, the flexible interior structure 210 is connected at two connection bridges 214, 214′ and is separated from the flexible exterior structure 220 along at least a portion of a tooth engaging surface by an aperture 226 positioned along the cephalad ridge 228 of the mandible isolation component 204 of the device 200.

The mandible isolation component 204 and the maxilla isolation component 202 are connected via a flexible and compressible spacer 240 that can, as illustrated herein, circumnavigate the facing edges of the mandible isolation component 204 and the maxilla isolation component 202. A variety of apertures can be provided in the device 200. For example, a distal aperture 250 can be provided at the distal end of the device to facilitate the passage of air through the mouth and into the throat during the procedure.

One illustration of the device as positioned in the oral cavity of a patient lying supine is shown in FIG. 2E along with relevant anatomy. The distal end 206 is located further away from the opening of the oral cavity, whereas the proximal end 208 is located closer to the oral cavity a distal aperture 250 can be provided at the distal end of the device to facilitate the passage of air through the mouth and into the throat during the procedure. FIG. 2F is a cross sectional illustration of FIG. 2E along the line a-a. FIG. 2F shows the maxilla isolation component 204 of the device positioned in the oral cavity 10 as viewed looking up at the soft palate 16 of the mouth. The teeth 20 and alveolar arch of the maxilla 40 come in contact with a seal 216 attached to a first flexible external structure 220 and a first flexible interior structure 210. In one embodiment, the flexible structures consist of a seal 216 to create a barrier seal between saliva containing spaces, the teeth 20 and the alveolar arches 32, 42 as the device is drawn up over the teeth and put into position in the oral cavity. The seal comprises a flexible structure adapted and configured to engage the surface. During this process some fluid may also be drawn away from the teeth and/or the gums. The device 200 may contain be configured to act as a protective shield for the soft palate 16 of the roof of the oral cavity 10. A distal aperture 250 can be provided at the distal end 206 of the device to facilitate the passage of air through the mouth and into the throat during the procedure. FIG. 2G shows the cross sectional view of the mandible isolation component 204 of the device positioned in the oral cavity 10 as viewed looking down at the device from above. As in FIG. 2G, the device is placed such that the device is drawn up over the teeth 22 and alveolar arches of the mandible 42, thereby creating a barrier seal between saliva containing spaces the teeth and the alveolar arch 42. The mandible isolation component 204 may also contain a seal 216 for drying the teeth and the alveolar processes. The device can also act as a tongue deflector 260 when positioned in the oral cavity. Further, the device extends into a tissue deflector 222 that deflects the cheeks and lips away from the ridge of the mandible 30.

The top of a dental device 200 is shown in FIG. 2H. The distal end 206 is place furthest from the opening of the oral cavity. The proximal end 208 is placed closest to the oral cavity opening. In one embodiment, a maxilla isolation component 202 passes over the teeth and the alveolar arch of the maxilla 40. The maxilla isolation component contains a seal 216 to create a barrier seal between saliva containing spaces and the surface of the teeth and alveolar arches. In addition, once positioned over the teeth and alveolar arch, the device further prevents new saliva from coming into contact with the surface of the teeth by forming a seal with either the teeth or the alveolar process. As shown in the embodiment of FIG. 2H, the device also may incorporate a tongue deflector 260. The tongue deflector 260 prevents the tongue from filing the oral cavity as a dental procedure is being performed. In addition, the tongue deflector 260 also prevents the tongue from being injured by any dental work. FIG. 2I is a cross sectional view of a device as shown in FIG. 2H along the line B-B. The cross section view cuts across a sagittal plane toward the right side of the patient. FIG. 2J shows a device as positioned in the mouth of a patient as viewed as a cross section. In FIG. 2J the device is shown to engage the teeth of an oral cavity of a patient. In one embodiment, the seal 216 of the device comes into contact with the surface of the teeth only. In another embodiment, the device comes into contact and wipes the alveolar processes of the mouth and creates a barrier seal between saliva containing spaces.

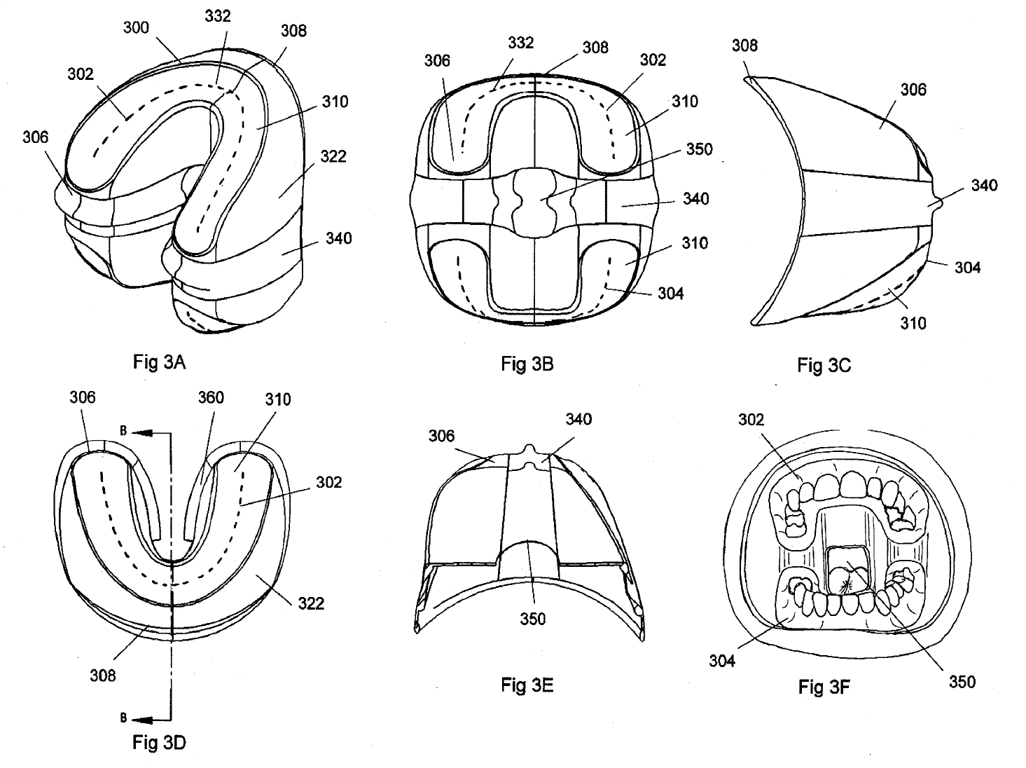

Turning now to FIG. 3 an embodiment of a dental device with a solid barrier 300 is shown. The device is a topology conformable device that can be constrained into a shape that can be delivered into an oral cavity and then unconstrained to allow the device to isolate one or more target teeth and initiate a working field. The device 300 includes a solid barrier 310 that allows for complete isolation of one or more of the teeth. As shown in FIG. 3A, one embodiment of the device 300 can have a solid barrier 310 that extends along either the maxilla isolation component 302 or the mandibular isolation component 304 or both the maxilla isolation component 302 and the mandibular isolation component 304. The solid barrier device 300 as shown in FIG. 3A is positioned so that the distal end 306 is further from the opening of the oral cavity 10, while the proximal end 308 is nearest to the oral cavity 10 opening. The maxilla isolation device 302 and the mandibular isolation device 304 are separated by a compressible and flexible spacer 340. The isolation components can further extend such that isolation components extend into a tissue deflector 322. As shown in FIG. 3B, in one embodiment of the device, the device contains an aperture 326 located at the back of the device. This aperture 326 ensures that the patient can breathe through the procedure as well as preventing debris from falling into the throat of the patient. In some embodiments, the solid barrier 310 can be present on both the maxilla isolation component 302 and the mandibular isolation component 304 of the device. In another embodiment, the solid barrier can be located on only either the maxilla isolation component 302 or the mandibular isolation component 304 of the dental device. FIG. 3C is an illustration of a solid barrier dental implant as viewed from the left side. FIG. 3D is an illustration of a top view of one embodiment of the solid barrier dental device 300. In some embodiments, the dental device 300 may consist of a tongue deflector 360. FIG. 3E is an illustration of a cross section of FIG. 3D along the line B-B as shown. The distal end 306 is placed farthest away from the opening of the oral cavity, whereas the proximal end 308 is placed closest to the opening of the oral cavity of a patient. A solid barrier may be desirable where access to soft tissue, instead of teeth, is desired. Perforations 332 may be provided on the upper surface such that the perforations can be separated to form a customized aperture adapted and configured to expose one or more teeth in the oral cavity of a particular patient.

FIG. 3F is an illustration of a frontal view of a dental device with a solid barrier 300 with a maxilla isolation component 302 and a mandibular isolation component 304 as positioned within the oral cavity 10 of a patient.

The dental device may designed such that only a minimal structural frame is apparent while retaining a topology conformable aspect. FIG. 4 is an example of a structural frame design of a dental device 400 with cutout areas 470. FIG. 4A is a perspective view of the posterior end 406 of a structural frame design of a dental device 400 as viewed from the top and at a 45 degree angle. The distal end 406 of the device 400 is positioned farther from the opening of the oral cavity (e.g. posteriorly). The proximal end 408 is positioned closest to the opening of the oral cavity (e.g. anteriorly). The maxillary isolation component 402 is separated from the mandibular isolation component 404 by flexible and compressible spacers 440 provide a compliant flexible area between an upper and lower portion of the device. Additionally, the device 400 may have cutout areas 470 incorporated into the device design. FIG. 4B is a bottom view of a structural frame design of a dental device with cutout areas 470. A structural frame design device 400 may incorporate a tongue deflector 460. FIG. 4C is an illustrative example of a structural frame design of a dental device with cutout areas as viewed from the distal end 406. A device 400 with cutouts 470 may incorporate a distal aperture 450. A distal aperture 450 can be provided at the distal end 406 of the device to facilitate the passage of air through the mouth and into the throat during the procedure. FIG. 4D is a structural frame design of a dental device with cutout areas 470 as viewed from the left side of the device.

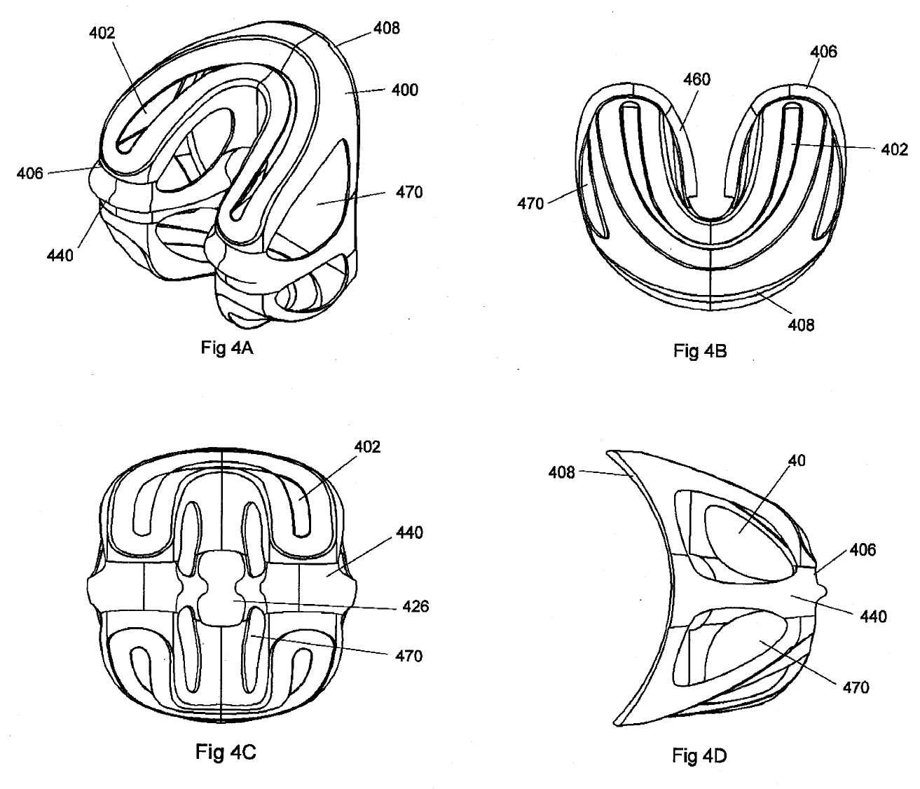

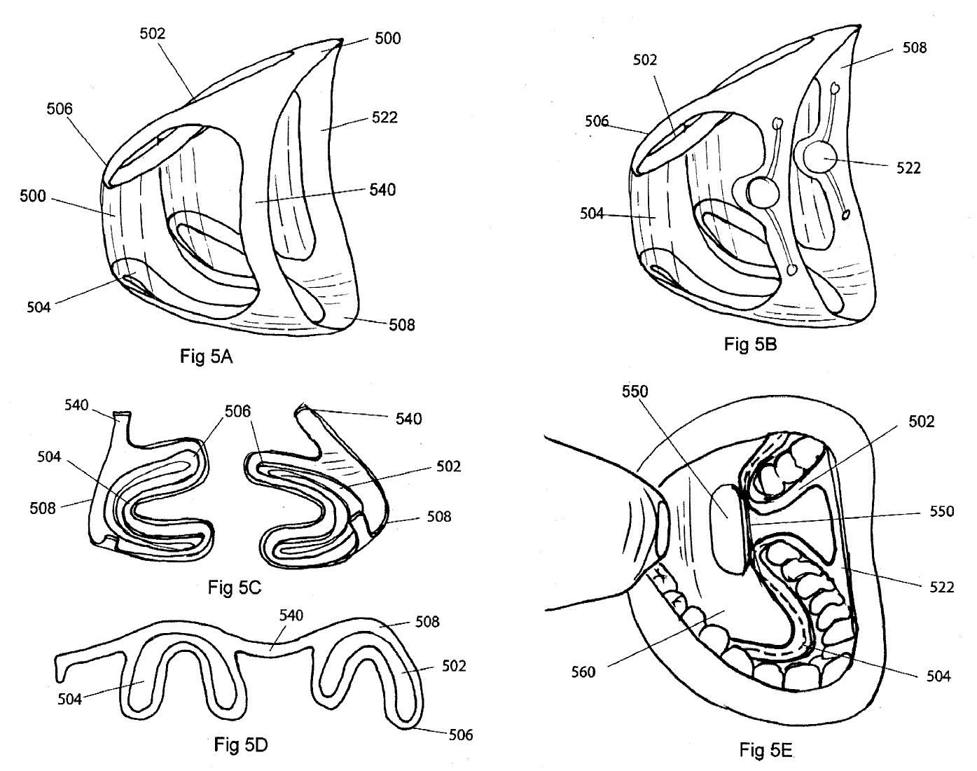

A dental device may be designed having a spring frame that enables it to be constrained into a shape that can be delivered into an oral cavity and then unconstrained to allow the device to isolate a target area, e.g. one or more teeth, and initiate a working field, this achieving a topology conformable device. FIG. 5 is an example of a dental device having spring frame 500. FIG. 5A is an illustration of a front view of a spring frame dental device showing one arch isolation of the top or bottom of the device. The distal end 506 of the device is placed further from the opening of the oral cavity. The proximal end 508 of the device is located closer to the opening of the oral cavity. As seen in FIG. 5A, the device can have a maxillary isolation component 502 and a mandibular isolation component 504. Further, a spring mechanism 550 is incorporated into the device 500 to account for variations in size of a patient's mouth. The isolation components can further extend into a tissue deflector 522 to retract the cheeks and lips of the patient. FIG. 5B is an illustration of a side view of a spring frame dental device showing the left or right half, upper and lower arch isolation. The device of FIG. 5b additionally has an integrated lighting mechanism 568. FIG. 5C is an illustration of a two-part assembly configuration of a spring frame dental device showing an unassembled view of the maxillary isolation component 502 and the mandibular isolation component 504 of the device 500. The device can be assembled by connecting the compressible and flexible spacers 540 forming a compliant flexible area located between the two components. FIG. 5D is a top view of a flattened single-piece assembly configuration of a dental device as one piece showing the maxillary 502 and mandibular 504 isolation components connected together. FIG. 5E is an illustration of a dental device 500 as positioned within the oral cavity of a patient. The device as shown is comprised of both the maxillary 502 and mandibular 504 isolation components. In such a design, the device may incorporate a distal aperture 550, in order to allow the patient to breathe during a dental procedure.

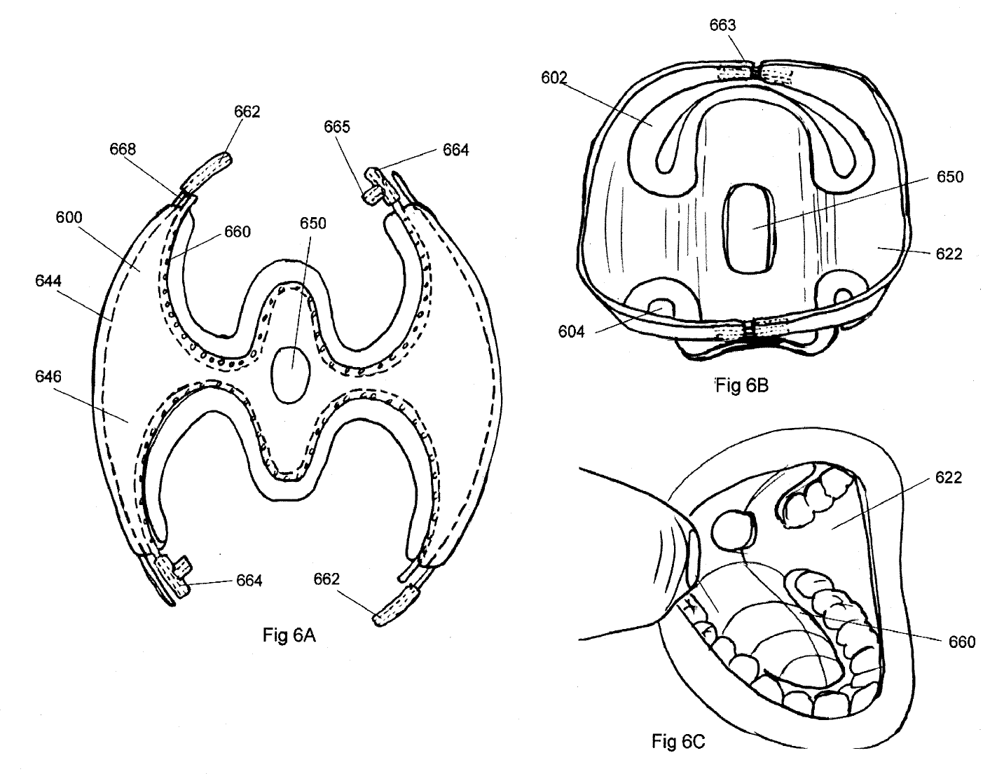

Dental devices, according to the invention may be a manufactured flat and then assembled by the user into a 3-dimensional device that form topology conformable devices able to have be constrained into a shape that can be delivered and then unconstrained into a deployed condition within the oral cavity. FIG. 6 shows one embodiment of the flat isolation device 600. As shown in FIG. 6A, the flat isolation device 600 may consist of a suction tube 660 and structural frame 644 with a biocompatible material 646 stretched or molded over the frame. FIG. 6A shows a flattened device 600 from the top. The flattened device can be configured to incorporate a suction tube 660 and a frame 644. The frame 644 is integrated within the structure of the device 600 such that it contributes to the structural properties of the dental device 600 after assembly. For example, the frame 644 can be a wire made of metal, or a rigid but bendable plastic. Once manufactured, in the desired three-dimensional, the shaped the dental device 600 can then be flattened for storage and shipment. The device 600 can also incorporate a distal aperture 650 that allows the patient to breathe during the procedure, but can be used without it without departing from the scope of the invention. The use of shape memory materials, such as Nitinol, facilitates bending and return to another shape, e.g., the final design shape.

The flattened dental device 600 is then assembled by the user prior to insertion. The structure of the dental device can be created through the use of the suction tube 660. As illustrated, the flattened isolation device has four connectors positioned at the ends 668 of the tubing 660 of the dental device. The connectors can be to configured to attach to the suction tubing, which consists of two male connectors 662 and two female connectors 664, as shown in FIG. 6A. The device is then assembled by joining the connectors 663, e.g. by inserting the male connector 662 into the corresponding female connector 664 resulting in an assembled device, as illustrated in FIG. 6B. As will be appreciated by those skilled in the art, the connectors of the tubing can be attached together by other techniques, such as the use of an adhesive. The female connector 663 can further comprise an external suction tube port 665. After joining the connectors, a maxillary isolation component 602 and a mandibular isolation component 604 is formed. The isolation components can further extend to a tissue deflector 622 to retract the cheeks and lips of the patient. The device 600 can then be positioned in the mouth of a patient as shown in FIG. 6C. FIG. 6C shows the assembled device as positioned in the mouth of a patient as viewed from the front at a 45 degree angle, isolating the maxillary alveolar arch 42 and the mandibular alveolar arch 32, as well as comprising a tongue deflector 660. The frame can be deployed as is or after a sheath, such as a disposable sheath of flexible polymer, is placed over the device.

FIG. 7 shows the dental device bisecting the oral cavity either sagitally or along an axial plane of the oral cavity. In FIG. 7 a half isolation dental device 700 is positioned within the oral cavity of a patient isolating half of the oral cavity. FIG. 7A is an illustration of a frontal view of a half isolation dental device 700 consisting of a maxillary isolation component 702 positioned in the oral cavity 10 of a patient isolating the left side or right side upper and lower alveolar arches 32,42 of the oral cavity of a patient. In a further embodiment, the half isolation dental device 700 consists of a tongue deflector 760. In another embodiment, the half isolation device isolates the left or right half of the maxillary and mandibular alveolar arches 32, 42 of the oral cavity. The maxillary and mandibular isolation component 702, 704 can further extend as a tissue deflector 722, to retract the cheeks and lips of the patient. In another aspect of the half isolation dental device 700, the dental device isolates the entire maxillary alveolar arch 42 or the entire mandibular alveolar arch 32 of the oral cavity as shown in FIG. 7B.

The half isolation dental device is pre-configured to isolate half of the oral cavity. Alternatively the half isolation device is created by a user prior to insertion in the oral cavity of the patient. Upon receipt of dental device isolating all quadrants of the oral cavity, the user may then cut the device either axially or sagitally in order to create a half isolation dental device 700.

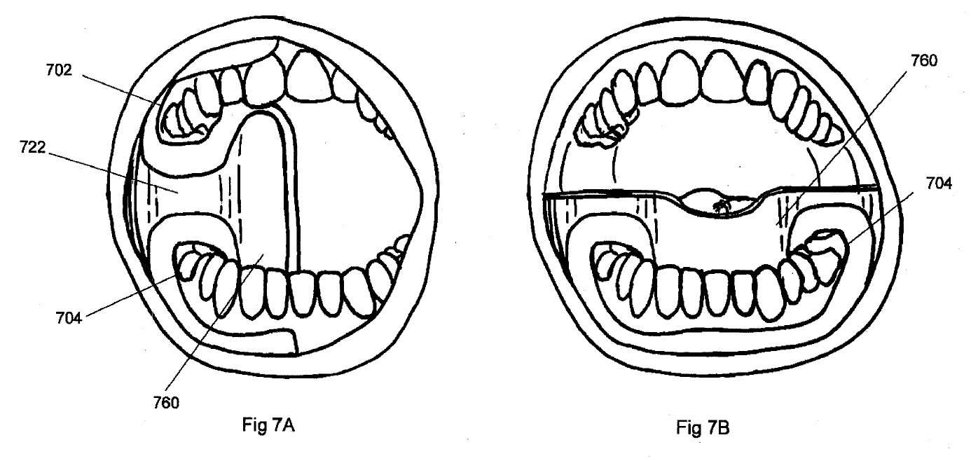

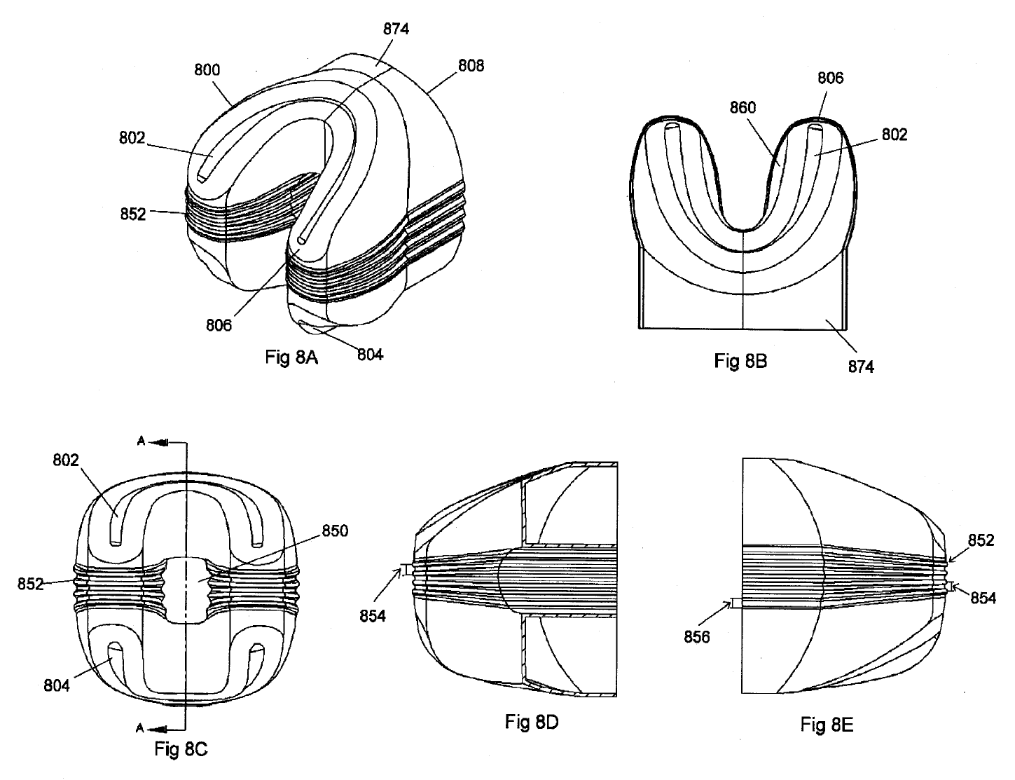

The dental device 800 may be designed such that the structure of the device is compressible along its vertical axis. The device is positioned such that the distal end 806 is positioned further from the opening of the oral cavity and the proximal end 808 is positioned closer to the opening of the oral cavity. FIG. 8 is an example of a compression accordion dental device 800 having vertical compliance. FIG. 8A is a perspective view of the distal end 806 of one embodiment of a compression accordion dental device 800 as viewed from the top and at a 45 degree angle. The compressible accordion device 800 can have a maxillary isolation device 802 and a mandibular isolation device 804. When inserted into a patient's mouth, the device automatically compresses to the size of the patient's mouth thereby self-adjusting for variations in patient anatomy. An accordion feature of a dental device can also acconmodate closing of the patient's mouth. In such an embodiment, the folds 852 of the dental device 800 can be approximately two. In other embodiments, the folds 852 of the dental device 800 can be approximately 10 in number. Folds 852 of the accordion style can be configured to vary from approximately 2 folds to approximately 10 folds. FIG. 8B is an illustration of a top view of a compression accordion dental device 800. A device ledge 874 can also be provided at the proximal end 808 of the dental device 800 extends further out. The device ledge 874 can be adapted to extend further from the mouth of a patient to keep the lips of the patient totally out of the way. In addition the isolation components can extend such that the device extends into a tissue deflector 822, thereby retracting the cheeks and lips of the patient. FIG. 8C is an illustration of the back or distal portion 806 of a compression accordion dental device 800. A distal aperture 850 may be present in order to allow the patient to breathe while the device is in position. FIG. 8D is a cross section of FIG. 8C along the line A-A as viewed from the midline toward the left side of the patient. The vertical dimension of the distal end 854, or spacing of the folds, of the accordion device can be configured such that it is smaller than the dimension of the proximal portion 856 of the device. The difference in dimension height is apparent when the device is viewed from the side, as shown in FIG. 8E. In another embodiment, the dimension of the folds is the same throughout the length of the dental device 800.

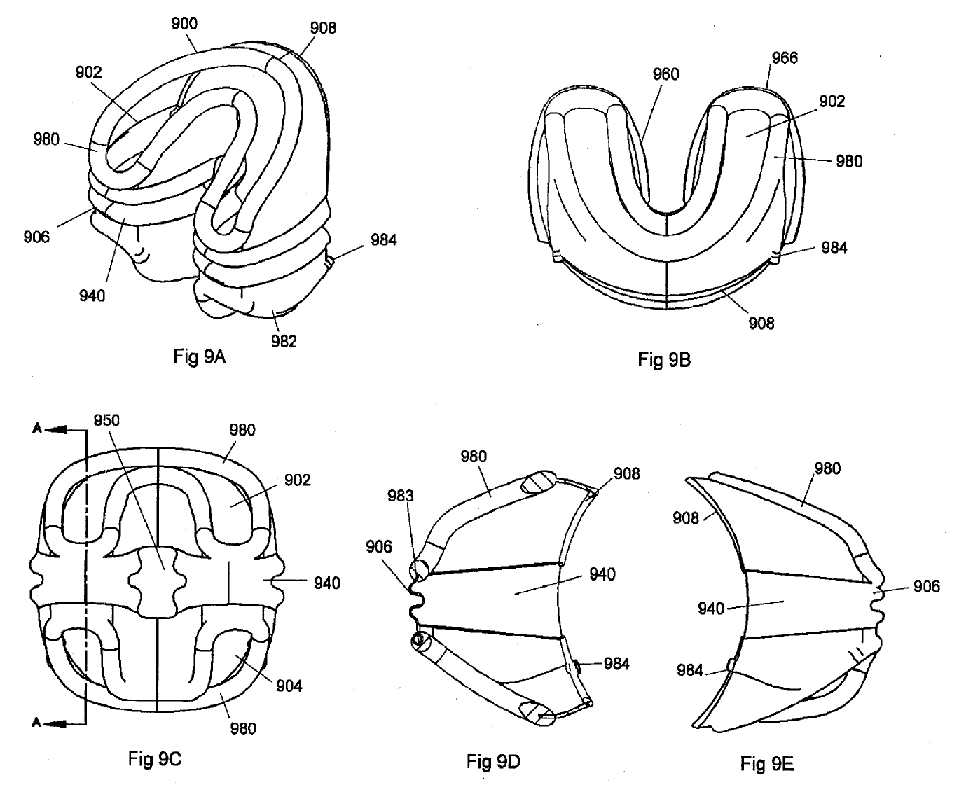

Turning now to FIG. 9, the dental device 900 can be manufactured such that a foam border 980 is incorporated into the device design. FIG. 9 is an example of a dental device 900 with an open/closed cell foam border 980 acting also as an extension of the suction feature. In some designs, suction is provided through the matrix of open cell foam; in some designs, suction is provided through both the apertures of the suction tube attachment 982 and through the matrix of the cell foam 980. In such an embodiment, the suction tube 982 is used together with the foam border 980 in order to create a seal around the teeth and the alveolar processes when placed in the maxillary isolation component 902 and the mandibular isolation component 904 separated by a compressible and flexible spacer 940. FIG. 9A is a perspective view of the distal portion 906 of a dental device 900 with a foam border 980 and a suction tube 982 as viewed from the top and at a 45 degree angle. FIG. 9B is an illustration of a top view of a dental device 900 with a foam border 980 and a saliva suction tube 982. In some embodiments, the dental device 900 is equipped with a tongue deflector feature 960. When positioned in the oral cavity, the device is positioned such that the distal portion 906 is positioned farther away from the opening of the oral cavity, and the proximal portions 908 is positioned closest to the opening of the oral cavity. The suction tube attachment ports 984 can be located on the left side and right side of the dental device as depicted. Alternatively, only one suction tube attachment port 984 may be provided in some configurations located on the device at either the left side or the right side of the device. FIG. 9C is an illustration of a distal end 906 of a dental device 900 with a foam border 980 and suction tube attachment 982. A distal aperture may be present to allow the patient to breathe 950 while the device is positioned within the oral cavity of the patient. Such an aperture can also prevent debris from flowing into the throat of the patient. FIG. 9D is an illustration of a cross section of FIG. 9C along line A-A. The suction tube 982 is attached to the foam border 980 at an attachment point 983. FIG. 9E is an illustration of the left side of a dental device 900 with a foam border 980 and a suction tube attachment 982. The suction tube attachment port 982 can be located on the maxillary isolation component 902 of the device and/or on the mandibular isolation component 904 of the device.

As described above, an additional element may be added to the dental device, in order to improve the seal between the device and the alveolar processes. A seal may be further formed by a foam border incorporated into the dental device 900. As will be appreciated a variety of configurations can be used. Form example, the foam border can be incorporated with a suction tube, the border can be made of gel, the border can be an inflatable membrane bag, or can be injection filled. Injection filling can include filling with gas, fluid, gel, foam or any other suitable material.

The dental device can also be configured to consist of a foam border, for example, a piece of foam can be cut and glued onto the bottom of the dental device allowing the dentist to selectively cut through the foam to expose the teeth that will be worked on. The foam border can be made from flat foam stock, or as a custom designed extrusion, a custom designed, pressure molded assembly, a custom fabricated assembly, can be sub-assembled, or assembled by the user.

Turning now to FIG. 10. The dental device 1000 includes a suction tube 1082 integrated therein to facilitate the removal of collected saliva from the oral cavity 10. As shown in FIG. 10, the dental device 1000 has a suction tube 1082 with sublingual saliva ejection holes 1088 and buccal saliva ejection holes 1086. FIG. 10A is a perspective view of a dental device 1000 with both a maxillary isolation component 1002 and a mandibular isolation component 1004 separated by a compressible and flexible spacer 1040, further integrating with sub-lingual suction holes 1088 and buccal suction holes 1086 suction as viewed from the top and at a 45 degree angle. As will be appreciated by those skilled in the art, the device can be adapted to expose only a portion of an alveolar arch as discussed above. The suction holes for both sub-lingual 1088 and buccal 1086 suction can be located toward the distal portion of the 1006 device. Alternatively, only sub-lingual suction holes 1088 may be located on the suction tubing 1082. In an alternative arrangement, buccal suction holes 1086 may be located on the suction tubing 1082. Alternatively, the suction holes 1086, 1088 can be located along the entire length of the suction tube 1082. The suction tube 1082 may also be located along the periphery of the mandibular isolation component 1004 of the dental device as shown in FIG. 10A. FIG. 10B is an illustration of a top view of a dental device with sub-lingual and buccal suction. Suction tube outlets 1092 can be located on only one side of the device. Alternatively, suction tube outlets 1092 can be located on both sides of the device. FIG. 10C is an illustration of a distal end 1006 of a dental device engaging both the maxillary and mandibular alveolar arches of the oral cavity, such device having both sublingual 1088 and buccal 1086 suction. FIG. 10D is an illustration of a cross section of FIG. 10C along line A-A. Saliva that enters the lumen 1090 of the suction tube 1082 through the sub-lingual 1088 and buccal 1086 suction holes of the device 1000 is then expelled out through the suction port 1092 of the suction tube 1082. The suction tube 1082 can be located on the mandibular isolation component 1004 of the dental device 1000 as shown in FIG. 10E. FIG. 10E is an illustration of the left side of a dental device 1000 with sublingual 1088 and buccal 1086 suction as viewed from the patient's left side.

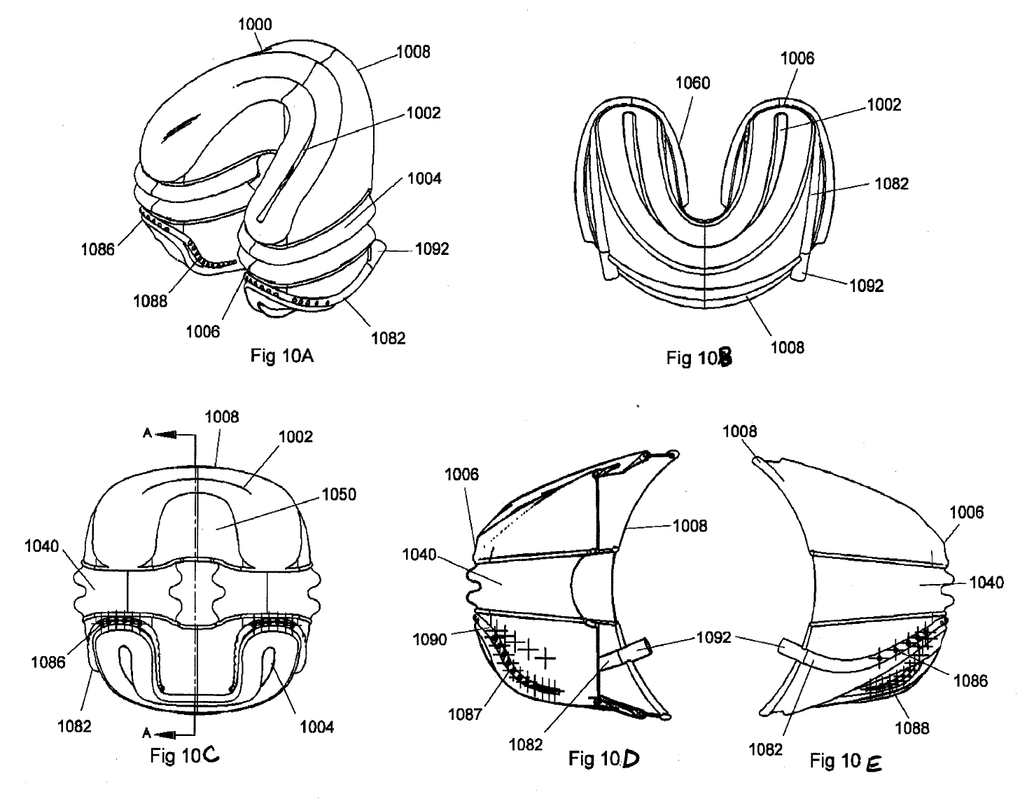

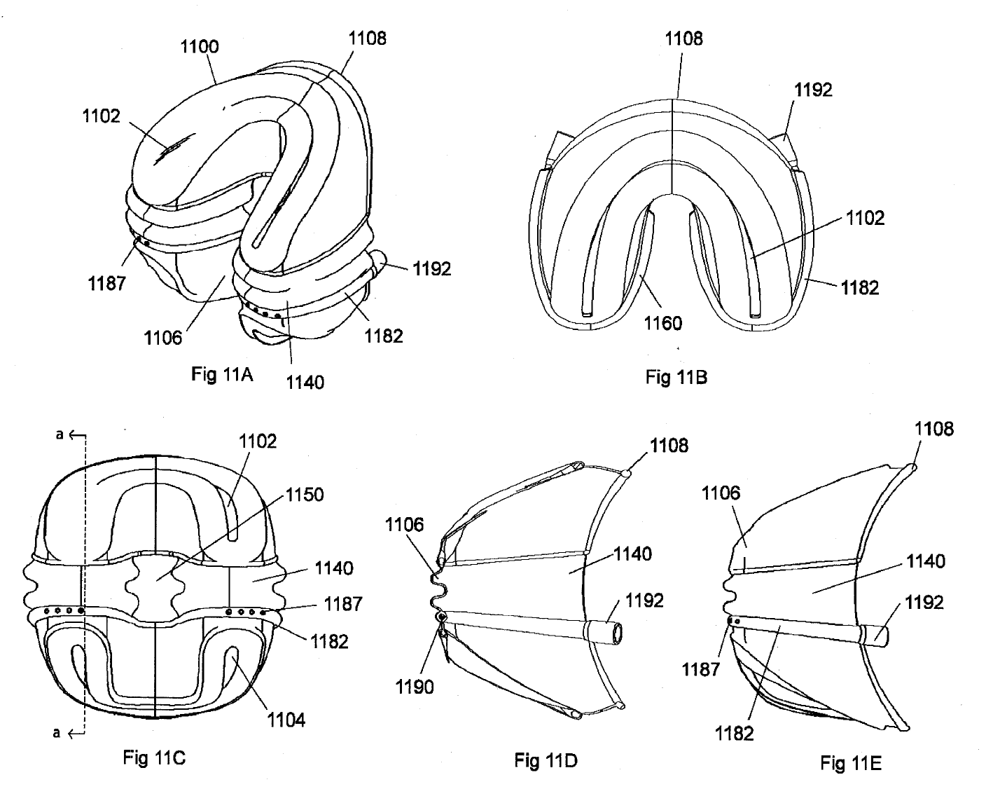

As shown on FIG. 11, the dental device 1100, can be adapted and configured to include a suction tube 1110 that is integrated into the dental device to facilitate saliva evacuation. FIG. 11A is an illustration of a perspective view of the dental device 1100 with a saliva suction tube 1182, as viewed from the top at a 45 degree angle. The device 1100 is inserted in the mouth 10 of the patient such that the distal portion 1106 is further away from the opening of the oral cavity 10, while the proximal portion 1108 is positioned such that it is closer to the opening of the oral cavity 10. The dental device 1100 is illustrated with both maxillary and mandibular isolation components 1102, 1104 incorporating a suction tube 1182, and saliva ejection holes 1187 located in the suction tube 1182. The device is designed to facilitate removal of saliva during a dental procedure. Other configurations can be employed without departing from the scope of the invention. For example, the saliva evacuation holes 1187 can be located on the suction tube 1182 at the distal portion 1106 of the device, or located along the entire length of the suction tube 1182. Saliva that collects in the mouth during a dental procedure is then drawn into the lumen 1190 of the suction tube 1182 and is evacuated out through the opening 1192 of the suction tube 1182, as shown in FIG. 11B. FIG. 11B further illustrates a dental device incorporating a suction tube 1182 as viewed from the top of the device 1100. As seen in the figure, the suction tube 1182 encompasses the perimeter of the device. The device can further include a tongue deflector 1160.

FIG. 11C shows the dental device 1100 as viewed from the distal end 1106 of the device. In this embodiment, the device as shown engages both the maxillary and mandibular alveolar arches of the oral cavity 10. The dental device is configured to have a distal aperture 1150 located in the back of the device, to allow for breathing, while preventing debris from entering the throat area. Saliva evacuation holes 1187 can also be seen to be located at the distal portion 1106 of the dental device 1100 as seen in FIG. 11C. Upon suction administration, provided for by an external source, saliva that has collected in the oral cavity 10 behind the dental device 1100 is drawn into the lumen 1190 of the suction tube 1182. The lumen 1190 of the suction tube 1182. FIG. 11D is a cross-sectional illustration of FIG. 11C along line A-A as viewed from the midline toward the patient's left side. Once saliva has been drawn through the saliva evacuation holes 1187 into the lumen 1190 of the suction tube 1182, the saliva is further evacuated out of the dental device 1100 through the suction tube attachment 1192. FIG. 11E is an illustration of the right side of a dental device 1100 with suction tube 1182. Saliva evacuation holes 1187 are shown located in the suction tube 1187 at the distal portion 1106 of the dental device.

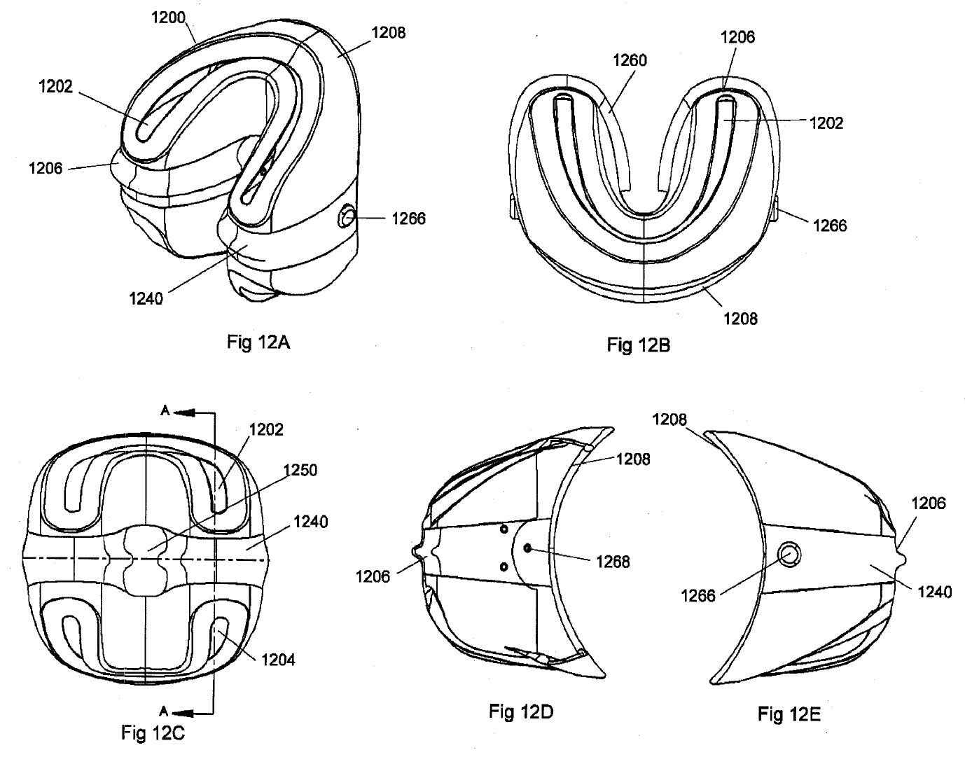

Other designs of a dental device may include a lighting mechanism for the oral cavity. FIG. 12 depicts a dental device in which a lighting mechanism 1268 is incorporated into the dental device 1200. FIG. 12A shows a dental device incorporating a lighting mechanism 1268 as viewed from the top at a 45 degree angle. FIG. 12A shows a dental device 1200 consisting of a maxillary and mandibular isolation device 1202, 1204, separated by a compressible and flexible spacer 1240. The distal portion 1206 of the dental device 1200 is positioned further from the oral cavity 10, whereas the proximal portion 1208 of the dental device 1200 is positioned nearest to the oral cavity 10. Such isolation mechanisms incorporate a seal 1216 to create a barrier seal between saliva containing spaces and the teeth as the device is being positioned in the oral cavity 10. FIG. 12A also depicts a power source 1266 to power the lighting mechanism 1268 of the dental device 1200. The power source 1266 can be in the form of a battery or it can be connected to an external power supply located somewhere else other than on the dental device itself. Alternatively, the power source can be positioned between the maxillary and mandibular isolation components 1202, 1204, closer to the maxillary isolation component 1202, or closer to the mandibular isolation component 1204. FIG. 12B shows a dental device integrating a lighting mechanism 1200 from the bottom of the device. FIG. 12B shows a power source 1266 as located on both sides of the dental device 1200. In other designs, the power source 1266 may be located on only one side of the dental device or external to the device. The device 1200 may also consist of a tongue deflector 1260. FIG. 12C is an illustration of the distal end 1206 of a dental device 1200 integrating a light source in which both the maxillary and mandibular alveolar arches 32,42 are isolated.

A cross section of the dental device 1200 shown in FIG. 12C reveals a lighting mechanism 1268 for the oral cavity. FIG. 12D depicts a cross section of FIG. 12C as shown in as viewed from midline toward a patient's left integrating a lighting mechanism 1268. The lighting mechanism 1268 can be in the form of a light emitting diode (LED). In one embodiment, there are three LED lights integrated into the dental device 1200. For example, there can be at least one LED light integrated into the dental device, two or more LED lights integrated into the dental device, or any other lighting device adaptable for use with the device. As shown in FIG. 12D, the lighting source can be incorporated into the physical structure of the dental device, or can be attached to the device after the device is manufactured (e.g. provided in a kit). The lighting source can be attached to the device by, for example, clipping the lighting mechanism 1268 onto the device or by attaching the lighting source 1266 to the device by means of an adhesive. FIG. 12E is an illustration of the left side of one embodiment of a dental device integrating a light source 1266, showing the power supply as located on the outer side of the dental device 1200.

As will be appreciated by those skilled in the art, the light mechanism, can also be provided using, for example, fiber optic lights that engage the device from exterior to the oral cavity. Additionally, the light mechanism can be provided such that it is disengageable, thus allowing the removal and replacement of the light. Other combinations and permutations can be employed without departing from the scope of the invention.

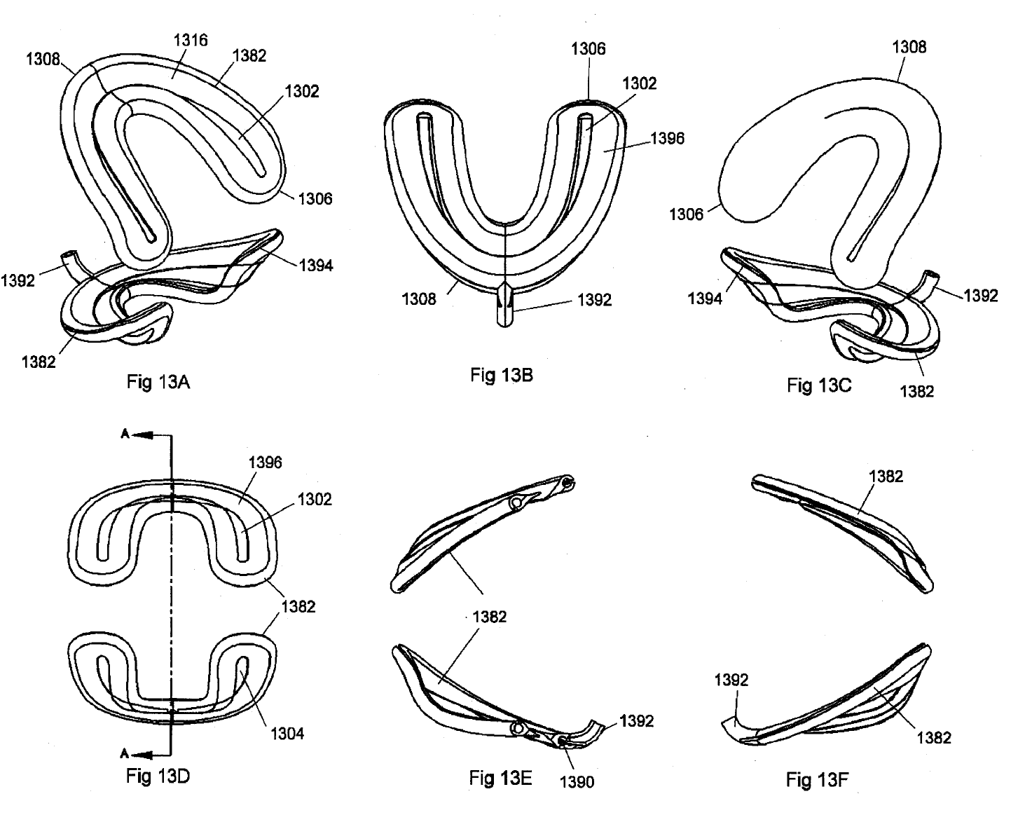

A full seal suction tube 1382 feature can also be added to the dental device 1300 to provide for saliva evacuation around the entire perimeter of the sealing mechanism. A full seal suction tube 1382 feature can also be added to assist in adherence of the dental device to soft tissue due to the suction. In such an configuration, the suction action can further enhance the seal between the device and the alveolar structures. As shown in FIG. 13, a suction tube 1382 can be manufactured to mimic the shape of a dental device 1300. A suction tube feature is shown in perspective view in FIG. 13A. The suction tube is shown as viewed from the top at a 45 degree angle. As will be appreciated by those skilled in the art, the suction tube 1382 can be adapted to fit to a dental device 1300 manufactured to isolate either the maxillary or the mandibular half of the oral cavity 10. The suction tube feature 1382 surrounds a seal 1316 that comes in contact with the teeth of a patient. The suction tube feature 1382 can have an attachment port 1392 to which an external suction device can be attached. In one embodiment, a suction tube feature 1382 is joined to a device isolating both the maxillary and mandibular portions of the oral cavity. The suction tube 1382 feature can also be attached to only one of either the maxillary or the mandibular isolation component of the dental device 1300. The suction tube 1382 feature can be attached to a dental device 1300 using a slot 1394 located on the suction tube 1382 feature for attachment of the suction tube 1382 to the structural component of the dental device 1300 as shown in FIG. 13A. The suction tube 1382 feature can be attached to the device 1300 prior to positioning the device in the oral cavity of a patient. Alternatively, the suction tube 1382 feature can be attached to the device after the structural component of the dental device 1300 has been positioned in the oral cavity 10 of patient. A top view of a full seal suction tube 1382 feature is shown in FIG. 13B. FIG. 13C is a perspective view of the distal end 1306 of a full seal suction tube component 1382 of a dental device 1300 as viewed from the top and at a 45 degree angle from the right side of a patient. The external suction attachment port 1392 is also apparent from both sides of the suction tube as is the slot 1394 for the attachment of the suction tube 1392 to the structural component of the device 1300.

The suction tube 1382 feature can also be attached to both the maxillary and mandibular isolation component 1302, 1304 of the dental device can be two independent pieces, as shown in FIG. 13D such as two independent units shown in FIG. 13D. A cross section of the suction tube feature shown in FIG. 13D along line A-A is shown in FIG. 13E. As shown in FIG. 13E, the lumen 1390 of the suction tube 1382 feature encompasses the entire perimeter of the suction tube feature 1382. After attachment of the suction tube 1382 feature to the structural component of the device 1300, when suction is applied, the suction tube feature 1382 tightens around the teeth. FIG. 13F shows the left side of a full seal suction tube component of a dental device.

The suction tube feature 1382 could be in the form of a kit made available separately from the dental device 1300 itself. Alternatively, the suction tube feature 1382 could be included together with the dental device sold as a kit, or consists of some disposable parts and some non-disposable parts. Such a kit might include, in addition to a suction tube adapted, or a separate element, a light source, an electrical power source for a light mounted to a primary device and/or an adapter configured to accommodate a light or electrical power source, The structural frame is non-disposable and the suction tube feature 1382, seal 1316, and a polymer sleeve are disposable.

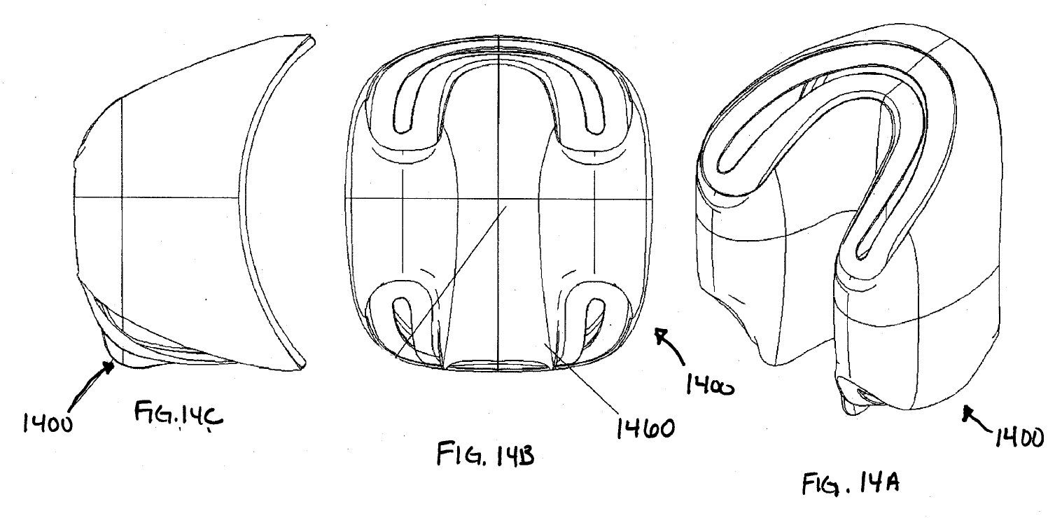

FIG. 14 illustrates a dental device 1400 with no center aperture. FIG. 14A is a perspective view of a dental device as viewed from the top and at a 45 degree angle; FIG. 14B is an illustration of a back end of the dental device of FIG. 14A; FIG. 14c is a side view of the dental device 1400. The device 1400 of FIG. 14 has many of the same features as previously described devices, e.g., FIG. 3. However, as will be appreciated by those skilled in the art, this device does not include a center hole. Removing the center hole may be advantageous in some situations where it desirable to prevent even small amounts of humidity, e.g. that might result from a patient's breathing, from contaminating the target area, e.g. a tooth surface being prepared for a bonding procedure. This design could be altered in situ, e.g., by snipping a hole in a location away from the site where the dental work is being performed, if necessary or desirable. Removing of the center hole may also be advantageous to reduce the likelihood that something will inadvertently be swallowed. Additionally, the device 1400 of FIG. 14 has a tongue stabilizer 1460 that is positioned below the tongue when the device is deployed to provide a location for the tongue to be positioned. Providing a platform on which to place the tongue is more comfortable for patients than depressing the tongue under a structure. The design facilitates a natural-passive fit position that can help stabilize the device in the mouth and make it more comfortable for the patient.

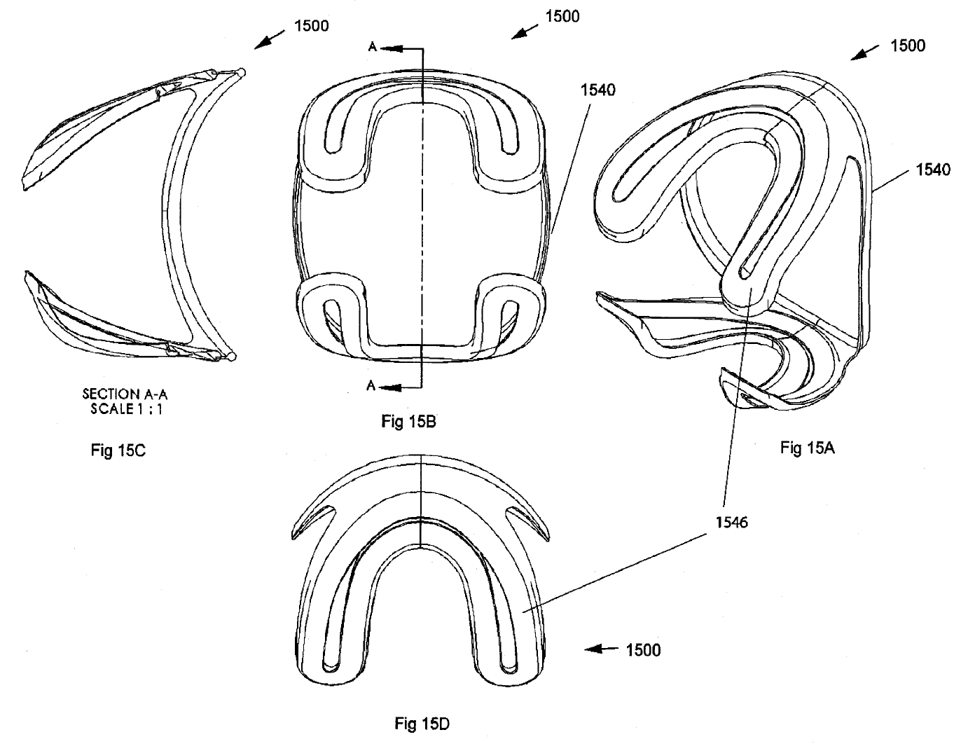

FIG. 15 illustrates a dental device 1500 having a flexible frame with a hydrophilic seal. FIG. 15A is a perspective view of a dental device 1500 as viewed from the top and at a 45 degree angle; FIG. 15B is an illustration of a back end of the dental device 1500 of FIG. 15A; FIG. 15C is a side view of the dental device; FIG. 15D is a top view of the dental device. The device 1500 has a flexible frame, e.g., a frame made from a shape memory material, with a hydrophillic seal. The spacer 1540 is formed from a springy compliant material, such as a shape memory plastic. A hydrophillic seal 1546 is provided to engage the upper surface of each alveolar arch engaged by the device.

### II. Method Of Use

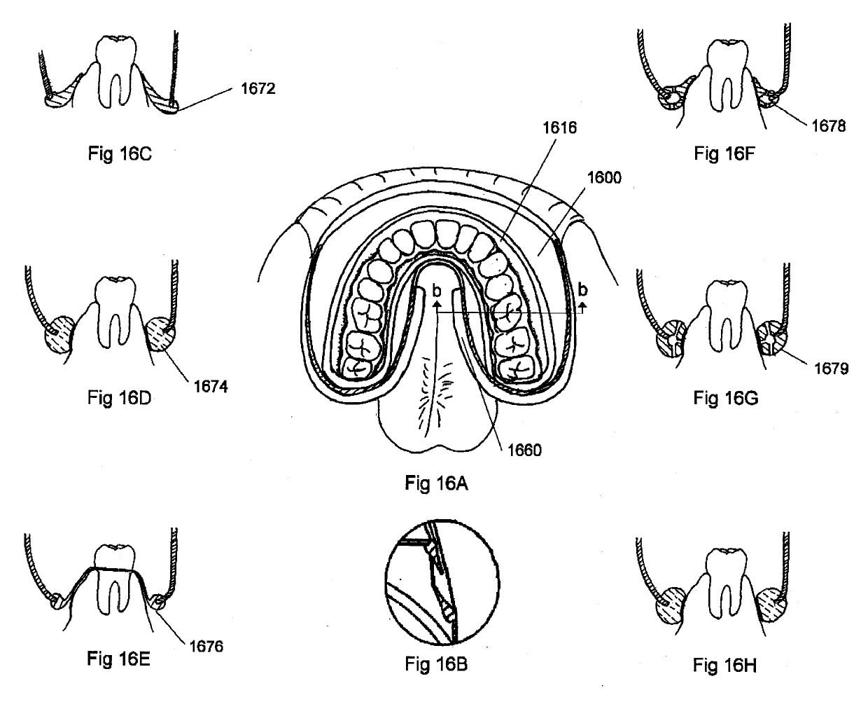

When positioned within the oral cavity of a patient, the dental device engages the teeth of the patient. FIG. 16 shows a dental device 1600 as placed on the mandible or lower portion of the oral cavity 10 of a patient. As the device is positioned into the oral cavity, the surface of the tooth is wiped by the seal 1616 to create a barrier seal between saliva containing spaces and the surface of the tooth. As shown in FIG. 16A, the dental device 1600 is positioned in the mouth 10, such that the dental device exposes and dries the surface of the teeth 22 and alveolar arch 42 of the patient. As will be appreciated by those skilled in the art, the number of teeth exposed is customizable such that only one or more teeth in one or more alveolar arches are exposed. FIG. 16B is a close up area of a seal assembly turning a seal between the dental device and the alveolar arch.

Different embodiments of the dental device can be employed to provide a seal around the tooth 22 and surround alveolar arch from the production of new saliva by the patient. During deployment, some wiping of the tooth and/or a portion of the alveolar arch may also occur. FIGS. 164C-14H are illustrations of various embodiments of a dental device as positioned in the oral cavity as viewed as a cross section of FIG. 16A along the line b-b. FIGS. 16C-14H illustrates the interaction between the various device configurations and the oral cavity 10. In one embodiment the device consists of flexible seals 1616 in the shape of flexible flaps 1672 attached to the flexible interior 210 and flexible exterior 220 surface of the dental device 1600 as shown in FIG. 16C. In such an embodiment, as the device 1600 is positioned on the teeth of the oral cavity 10, the seal 1672 wipes or slides over the surface of the tooth 20 and over part of the alveolar arch. The seal 1672 portion forms a seal with the gingiva thereby preventing any new production of saliva from coming in contact with the tooth surface. In another embodiment, the seal 1616 is a compressible structure 1674, as shown in FIG. 16D. In such an embodiment, the seal 1616 structure deforms to conform to the shape of the tooth and gingiva as the device is positioned, thereby sealing out saliva. In another embodiment the seal 1616 comes to rest at the base of the tooth 20, resting on the surface of the gingiva, as shown in FIG. 16E. In such an embodiment the sealing seal 1676 only wipes the surface of the tooth and not the gingiva. However, when positioned over the surface of the tooth, the seal 1616 comes to rest on top of the gingiva, thereby forming a barrier to prevent saliva from coming in contact with the tooth surface. In another embodiment, the seal 1616 portion of the device is incorporated with an external suction device. In such an embodiment, the wiper 1678 is manufactured with a suction tube feature 1682, as shown in FIG. 16F. In this embodiment, the seal 1616 wipes the surface of the tooth. A seal is then formed when the air in the lumen 1627 is suctioned out by an external suction device. The seal then prevents saliva from coming in contact with the surface of the tooth. In another embodiment, the seal 1616 consists of a compressible structure incorporated together with a fillable membrane bag, described above, as shown in FIG. 16H. As in the previous embodiment, the seal 1616 compresses when drawn over the surface of the tooth and gingiva, thereby drying those surfaces. After being positioned over the alveolar processes, the membrane can then be filled by the methods described above thereby creating a seal between the device 1600 and the alveolar arches, and thereby maintaining a dry environment. FIG. 16H illustrates yet another seal design suitable for use with any of the device designs of the invention.

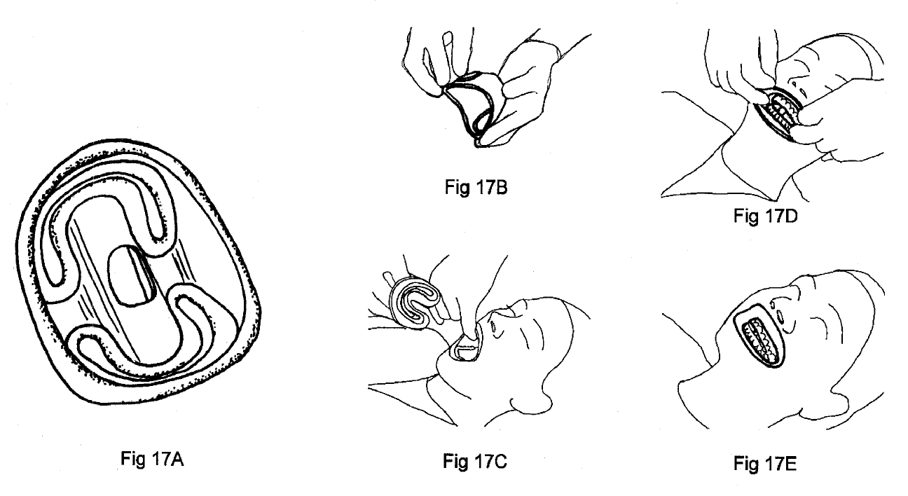

The dental device described above has the advantage of being positioned in less than two minuets, less than a minute, less than 30 seconds and optimally in less than 10 seconds. On method for inserting and positioning the dental device 1700 is shown in FIG. 17. This figure shows the device as being inserted by a medical professional into the oral cavity of a patient. The dental device 1700 as shown is adapted to engage both the caudad and cephalad portions of the oral cavity. FIG. 17A is an illustration of one embodiment of a dental device 1700 prior to insertion. FIG. 17B shows a first step for positioning a dental device meant to engage both the caudad and cephalad portions of the oral cavity. In this step, the profile of the device is reduced by squeezing the device. The dental device can be compressed, either by pressing on the top and bottom, or by pressing on the sides, to reduce the profile of the device to adjust for the size of the oral cavity of the patient. The device can be compressed to reduce the profile to allow for one-handed insertion. As seen in FIG. 17C a second step for positioning a dental device consists of adjusting the opening of the patient's mouth. In this example step for positioning a dental device, a dental device for isolation of half of the oral cavity is beginning to be inserted into the oral cavity. Step three of the positioning of the device is shown in FIG. 17D. Once the device is inserted into the patient's oral cavity is it adjusted so that it is positioned so that the teeth are completely exposed and dried. The device as finally positioned in the patient's oral cavity is shown in FIG. 17E. One advantage of the device design is that it can be completely positioned within less than two minutes and optimally in less than 10 seconds.

### III. Materials Of Manufacture

As will be appreciated by those skilled in the art, the devices described herein, and other device designs that can be employed under the invention based on the teachings herein, and their components can be made from a variety of materials known in the art. Candidate materials for the devices and components would be known by persons skilled in the art and include, for example, the materials described above as well as suitable biocompatible materials such as metals (e.g. stainless steel, shape memory alloys, such a nickel titanium alloy nitinol) and engineering plastics (e.g. polycarbonate). See, for example U.S. Pat. Nos. 5,190,546 to Jervis for Medical Devices Incorporating SIM Memory Alloy Elements and 5,964,770 to Flomenblit for High Strength Medical Devices of Shape Memory Alloy. For example, a device frame may be made of materials such as titanium, cobalt chrome stainless steel. Alternatively, a sheath or outer layer covering a frame can be made of biocompatible polymers such as polyetheretherketone (PEEK), polyarylamide, polyethylene, and polysulphone. See, for example U.S. Pat. Nos. 5,190,546 to Jervis for Medical Devices Incorporating SIM Memory Alloy Elements and 5,964,770 to Flomenblit for High Strength Medical Devices of Shape Memory Alloy. Other materials may be appropriate for some or all of the components, such as biocompatible polymers, including polyetheretherketone (PEEK), polyarylamide, polyethylene, and polysulphone. 5,964,770 to Flomenblit for High Strength Medical Devices of Shape Memory Alloy.

A variety of hydrophillic materials, hydrophobic materials, or putties can also be used, e.g. to form seals. Such materials would be known to a person skilled in the art and include, for example, hydrophilic material or a putty (e.g., Van-R reversible hydrocolloid, available from Dux Dental, and vinyl polysiloxane, available from 3M Express), as discussed above. Other materials that might also be used include, for example, poly(vinyl alcohol) (PVA) hydrogels, hydrophillic, medical grade foam, polysaccharides, glucosaminoglycans.

### IV. Kits

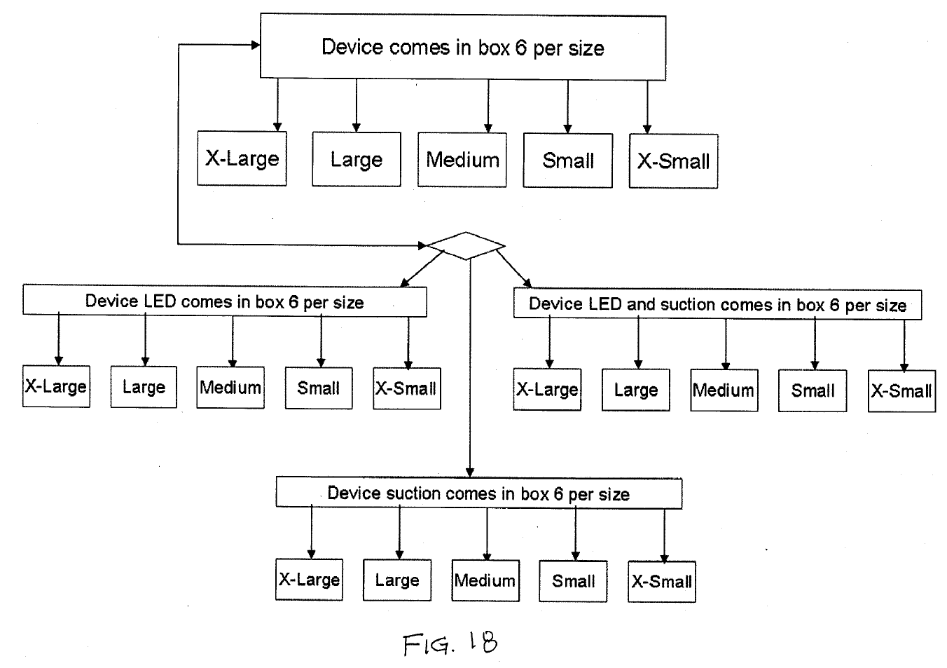

The dental device as described above can be sold as a kit to the consumer. The kit can include a variety of items, including but not limited to: materials suitable for a particular dental procedure (e.g., root canal, filling, whitening, tooth impressions, etc.), several try-in devices suitable for determining the size of the patient's mouth, one or more dental device, one or more light fixtures adapted to engage the dental device, kit containing different assembly methods of sealing device depending on the procedure, etc. FIG. 18 depicts examples of various ways that the device can be packaged and sold. The dental device comes in a box with devices of varying size. The devices can be sized as X-Small, Small, Medium, Large, and X-Large. The devices can be sold in boxes with six devices per size. Alternatively, the devices can be sold as individual units. In another embodiment, the devices incorporating a lighting mechanism can be sold in boxes of six with varying sizes. Alternatively, the devices can be sold as individual units. The devices can be sized as X-Small, Small, Medium, Large, and X-Large. In another embodiment, the dental devices can be sold with a suction tube feature. In another embodiment, the devices together with a suction tube feature can be sold in boxes of six with varying sizes. Alternatively, the devices can be sold as individual units. The devices can be sized as X-Small, Small, Medium, Large, and X-Large. In another embodiment the devices incorporating a lighting mechanism can be sold together with a suction tube feature. The devices incorporating a lighting mechanism together with suction tube features can be sold in boxes of six. The devices can be sized as X-Small, Small, Medium, Large, and X-Large. In all of the above mentioned embodiments of the kits for selling the dental device, each box can include all sizes of devices. In other embodiments, the kits contain three sizes of devices.

In further embodiments of the kits for packaging and selling the dental devices, the dental device can be packaged together with impression trays for taking crown and bridge impressions while the device is positioned in the mouth to ensure that saliva does not interfere with the dental impressions. Such impression kits can include but are not limited to the impression materials and trays for making the impressions in. By way of example, such impression tray materials can include, but are not limited to, trays made from vinyl polysiloxsane (VPS).

In further embodiments, the dental device can be packaged or used together with kits for orthodontic bracket bonding, including cement materials, etching materials, and bonding agents. In a further embodiment, the dental device can be packaged together with a porcelain bonding system kit for delivering a case of veneers. Further, the porcelain bonding kit system can include a porcelain cementation system. In another embodiment, the dental device can be packaged together with a kit for performing laser therapy in the mouth. In such an embodiment, the dental device can be used to protect soft tissue from errant laser beams. Further, the device can be used to isolate the field in which the laser beam will be used. In another embodiment, the dental device can be packaged with a whitening or bleaching kit. In some embodiments, the whitening or bleaching kit can be a bright smile custom made or stock bleaching tray.

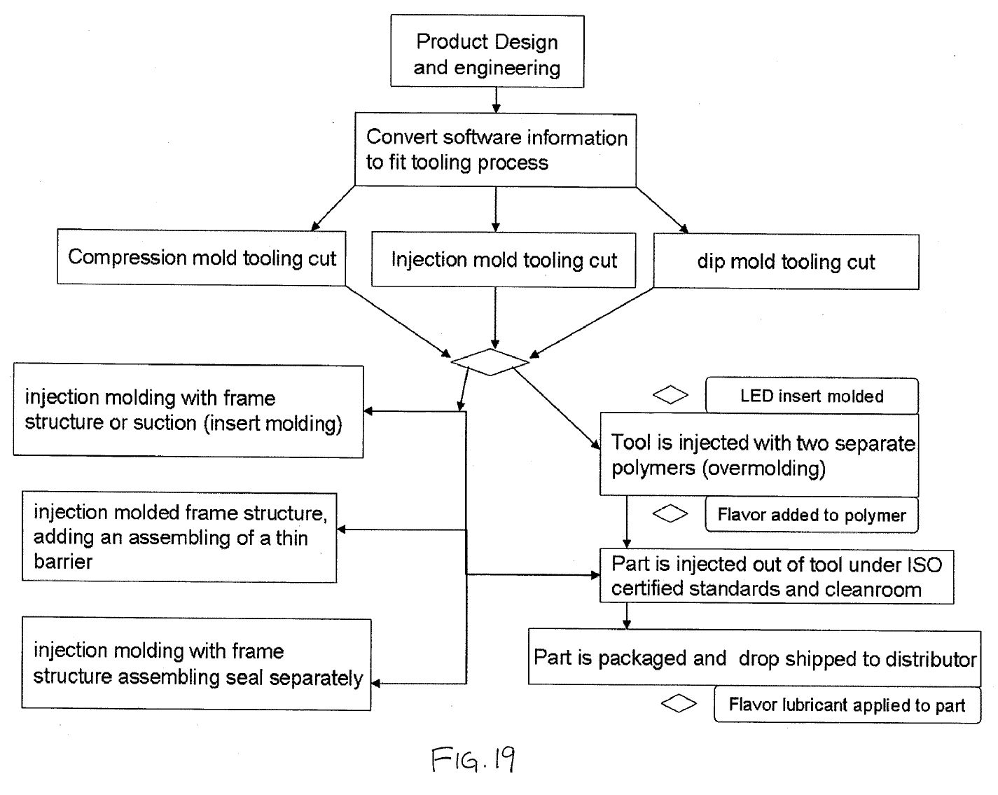

A manufacturing process for a dental device as described above is described in FIG. 19. The product is first designed according to the measurements of the patient's mouth or to standard measurements of the oral cavity of the average person. The information or specifications are then converted by software to fit the tooling process for manufacturing the device. The device is then fabricated by, for example, injection molding, compression molding, thermal forming, dip molding, rotation molding and blow molding tooling cuts.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

What is claimed is:

1. A tooth isolation device comprising a topology conformable device that can be constrained into a shape that can be delivered into an oral cavity and unconstrained to allow the device to isolate a target tooth and initiate a dry working field.

2. The device of claim 1 wherein the device is adapted and configured to isolate a working field from gingival tissue.

3. The device of claim 1 wherein the device is adapted and configured to isolate a working field from fluid.

4. The device of claim 1 wherein the device forms a customizable seal within the oral cavity.

5. The device of claim 1 further comprising:
a first flexible interior structure adapted and configured to engage an interior surface of an alveolar arch within the oral cavity; and
a first flexible exterior structure, connected to the interior structure, adapted and configured to engage an exterior surface of the alveolar arch.

6. The device of claim 5 further comprising:
a second flexible interior structure adapted and configured to engage an interior surface of a second alveolar arch within the oral cavity; and
a first flexible exterior structure, connected to the interior structure, adapted and configured to engage an exterior surface of the second alveolar arch.

7. The device of claim 1 further comprising a tongue deflector.

8. The device of claim 1 further comprising a lumen within at least one of the interior structure or the exterior one or more fluid apertures along the length of the lumen communicating the lumen with an interior of the oral cavity.

9. The device of claim 8 further comprising an external suction attachment port operably connected to the lumen.

10. The device of claim 8 wherein the fluid apertures comprise one or more of ventral apertures, sub-lingual apertures and bucal apertures.

11. The device of claim 1 further comprising a foam border.

12. The device of claim 6 further comprising a compliant flexible connector adapted to connect the first flexible exterior structure to the second flexible exterior structure.

13. The device of claim 6 further comprising a spacer positioned between the first flexible exterior structure to the second flexible exterior structure.

14. The device of claim 1 further comprising a light source.

15. The device of claim 1 further comprising lateral apertures in the external structure.

16. The device of claim 1 further adapted to fit the oral cavity to deflect one or more tissues away from the alveolar arch of the oral cavity.

17. The device of claim 1 whereby the dental device is engaged in the oral cavity in under 2 minutes.

18. The device of claim 1 wherein the dental device is adapted and configured to initiate a working field in an oral cavity in under 2 minutes.

19. The device of claim 1 further comprising a lubricant dispenser.

20. The device of claim 1 further comprising an inflatable membrane adapted and configured to isolate one or more target sections of teeth and gums.

21. The device of claim 20 further adapted to provide a fluid filled inflatable membrane.

22. The device of claim 1 further comprising a seal adapted and configured to isolate a target area of an alveolar arch to create a saliva barrier within the oral cavity.

23. The device of claim 1 further comprising a structural frame within a flexible biocompatible material.

24. The device of claim 23 wherein the structural frame is positioned within a flexible sleeve.

25. The device of claim 24 wherein the flexible sleeve is a disposable flexible sleeve.

26. The device of claim 1 further comprising a dispenser adapted and configured to administer a topical anesthetic.

27. The device of claim 1 further comprising a posterior aperture adapted and configured to permit breathing when the device is deployed.

28. A tooth isolation device for use in a mammal comprising
a first flexible interior structure adapted and configured to engage an interior surface of an alveolar arch within the oral cavity; and
a first flexible exterior structure, connected to the interior structure, adapted and configured to engage an exterior surface of the alveolar arch,
wherein the isolation device adapted and configured to fit a topology of a mouth cavity to retract tissue from contacting the alveolar arch to initiate a working field, wherein the device is adapted and configured to be deployed in less than two minutes.

29. The device of claim 28 further comprising:
a second flexible interior structure adapted and configured to engage an interior surface of a second alveolar arch within the oral cavity; and
a second flexible exterior structure, connected to the interior structure, adapted and configured to engage an exterior surface of the second alveolar arch.

30. The device of claim 28 further comprising a tongue deflector.

31. The device of claim 28 further comprising a lumen within at least one of the interior structure or the exterior structure and one or more fluid apertures along the length of the lumen communicating the lumen with an interior of the oral cavity.

32. The device of claim 28 further comprising a light source.

33. The device of claim 28 further adapted to fit the oral cavity to deflect one or more tissues away from the alveolar arch of the oral cavity.

34. The device of claim 28 further comprising a seal adapted and configured to isolate a target area of an alveolar arch to create a saliva barrier within the oral cavity.

35. The device of claim 28 further comprising a structural frame within a flexible biocompatible material.

36. A tooth isolation device for use in a mammal comprising:
a first flexible interior structure adapted and configured to engage an interior surface of an upper alveolar arch within the oral cavity;
a first flexible exterior structure, connected to the interior structure, adapted and configured to engage an exterior surface of the upper alveolar arch,
a second flexible interior structure adapted and configured to engage an interior surface of a lower alveolar arch within the oral cavity;
a second flexible exterior structure, connected to the interior structure, adapted and configured to engage an exterior surface of the lower alveolar arch,
wherein isolation device adapted and configured to fit a topology of a mouth cavity to deflect tissue from contacting the alveolar arch to initiate a working field, and further wherein the device is adapted and configured to be deployed to isolate in a single step.

37. The device of claim 36 further comprising a tongue deflector.

38. The device of claim 36 further comprising a lumen within at least one of the interior structure or the exterior structure and one or more fluid apertures along the length of the lumen communicating the lumen with an interior of the oral cavity.

39. The device of claim 36 further comprising an external suction attachment port operably connected to the lumen.

40. The device of claim 36 further comprising a light source.

41. The device of claim 36 further adapted to fit the oral cavity to deflect one or more tissues away from the alveolar arch of the oral cavity.

42. The device of claim 36 whereby the dental device is engaged in the oral cavity in under 2 minutes.

43. A tooth isolation device comprising a device that is configured to be deliverable into a patient's oral cavity and configured to deflect tissue away from one or more alveolar arches in the oral cavity while allowing fluid from one or more glands in the oral cavity to flow away from the alveolar arches and teeth.

44. The device of claim 43 further comprising:
a first flexible interior structure adapted and configured to engage an interior surface of an upper alveolar arch within the oral cavity; and
a first flexible exterior structure, connected to the interior structure, adapted and configured to engage an exterior surface of the upper alveolar arch.

45. The device of claim 44 further comprising:
a second flexible interior structure adapted and configured to engage an interior surface of a lower alveolar arch within the oral cavity; and
a first flexible exterior structure, connected to the interior structure, adapted and configured to engage an exterior surface of the lower alveolar arch.

46. An integrally formed tooth isolation dental device for use in an oral cavity of a mammal comprising:
a first flexible interior structure adapted and configured to engage an interior surface of an alveolar arch within the oral cavity, further comprising a first interior seal, along at least a portion of a first edge thereof, adapted and configured to draw fluid from the interior surface of the alveolar arch during deployment; and
a first flexible exterior structure, connected to the interior structure at a posterior end, adapted and configured to engage an exterior surface of the alveolar arch, further comprising a first exterior seal, along at least a portion of a first edge thereof, adapted and configured to draw fluid from the exterior surface of the alveolar arch during deployment, and a curved trough at an opposing edge to the first edge adapted and configured to deflect tissue away from the alveolar arch,
the tooth isolation device being dimensioned to fit over one or more of an upper alveolar arch, a lower alveolar arch, an upper quadrant of the alveolar arch, and a lower quadrant of the alveolar arch.

47. The device of claim 46 further comprising:
a second flexible interior structure adapted and configured to engage an second interior alveolar arch surface within the oral cavity, further comprising a second interior seal, along at least a portion of a leading edge thereof, adapted and configured to draw fluid from the second interior alveolar arch of the oral cavity during deployment; and
a second flexible exterior structure, connected to the second interior structure at a posterior end, adapted and configured to engage a second exterior alveolar arch of the oral cavity, further comprising a second exterior seal, along at least a portion of a leading edge thereof, adapted and configured to draw fluid from the second exterior alveolar arch of the oral cavity during deployment, and a curved trough at a trailing external edge adapted and configured to deflect tissue away from the alveolar arch
the connected first flexible interior structure and first flexible exterior structure further adapted and configured to connect to the second flexible interior structure and the second flexible exterior structure.

48. The device of claim 47 further comprising a compliant flexible connector adapted to connect the first flexible exterior structure to the second flexible exterior structure.

49. The device of claim 46 further comprising a light source.

50. A dental device for use in an oral cavity of a mammal comprising:
a first flexible caudad interior wall adapted and configured to engage an interior caudad arch of the tooth within an oral cavity of a mammal, further comprising an interior caudad seal along at least a portion thereof adapted and configured to draw fluid from the interior arch of the oral cavity during deployment;
a first flexible caudad exterior wall, connected to the interior wall, adapted and configured to engage an exterior caudad arch of an oral cavity of a mammal, further comprising an exterior caudad seal along at least a portion thereof adapted and configured to draw fluid from the exterior arch of the oral cavity during deployment;
a first flexible cephalad interior wall adapted and configured to engage an interior cephalad arch of the tooth within an oral cavity of a mammal, further comprising an interior cephalad seal along at least a portion thereof adapted and configured to draw fluid from the interior arch of the oral cavity during deployment;
a first flexible cephalad exterior wall, connected to the interior wall, adapted and configured to engage an exterior cephalad arch of an oral cavity of a mammal, further comprising an exterior cephalad seal along at least a portion thereof adapted and configured to draw fluid from the exterior arch of the oral cavity during deployment.

51. The device of claim 50 further comprising a light source.

52. A tooth isolation device comprising a device that is configured to be deliverable into a patient's oral cavity comprising a light delivery apparatus incorporated therein adapted and configured to deliver light to a target portion of the oral cavity.

53. The device of claim 52 further comprising:
a first flexible interior structure adapted and configured to engage an interior surface of an upper alveolar arch within the oral cavity; and
a first flexible exterior structure, connected to the interior structure, adapted and configured to engage an exterior surface of the upper alveolar arch.

54. The device of claim 53 further comprising:
a second flexible interior structure adapted and configured to engage an interior surface of a lower alveolar arch within the oral cavity; and
a first flexible exterior structure, connected to the interior structure, adapted and configured to engage an exterior surface of the lower alveolar arch.

55. The device of claim 53 further comprising a light source.

56. The device of claim 53 whereby the dental device is engaged in the oral cavity in under 2 minutes.

57. A method of achieving a working field in an oral cavity comprising the steps of:
inserting a dental device adapted and configured to draw fluid from an alveolar process and gingiva when engaged in the oral cavity;
drawing the dental device over the alveolar process;
seating the device in the oral cavity; and
isolating the working field from fluid from during the procedure.

58. The method of claim 57 wherein the step of inserting the dental device is performed in under 2 minutes.

59. A method of achieving a working field in an oral cavity comprising the steps of:
inserting a dental device adapted and configured to draw fluid from the oral cavity during use;
drawing the dental device over the alveolar process;
isolating the working field from fluid; and
applying suction to the dental device to withdraw fluid from the oral cavity through ejection apertures situated within the device.

60. A method of illuminating an oral cavity during a dental procedure comprising the steps of:
inserting a dental device adapted and configured to isolate a target region of an alveolar process and gingiva;
drawing the dental device over the alveolar process to expose the target region of the alveolar process and gingiva;
isolating the working field from fluid; and
activating a light in the dental device.

61. The method of claim 60 wherein the step of inserting the dental device is performed in under 2 minutes.

62. A method of initiating a working field comprising the steps of:
inserting a dental device adapted and configured to isolate a target region of an alveolar process and gingiva in under 2 minutes.

63. A kit for achieving a working field in an oral cavity comprising:
a dental device adapted and configured to draw fluid from an alveolar process and gingiva after engaging the oral cavity; and
a kit of a secondary dental procedure where a working field in the oral cavity is desirable.

64. The kit of claim 63 further comprising a whitening or bleaching kit.
